(19) United States
(12) Patent Application Publication
(10) Pub. No.: US 2025/0084707 A1
(43) Pub. Date: Mar. 13, 2025

(54) PASSIVE ROTATION DISCONNECT

(71) Applicant: NATIONAL OILWELL VARCO, L.P., Houston, TX (US)

(72) Inventor: Dominick Mancuso, Tomball, TX (US)

(21) Appl. No.: 18/888,008

(22) Filed: Sep. 17, 2024

Related U.S. Application Data
(63) Continuation of application No. 17/907,705, filed on Sep. 29, 2022, now Pat. No. 12,116,846.
(60) Provisional application No. 63/019,366, filed on May 3, 2020.

(51) Int. Cl. E21B 17/02; B23B 31/107

(52) U.S. Cl. CPC E21B 17/021; B23B 31/1071

(57) ABSTRACT

A coupling mechanism for securing a tool to a tool arm may include a housing and an engaging lock. The engaging lock may be arranged within the housing and configured for rotation by the tool arm. Rotation of the engaging lock may drive locking mechanisms partially through the housing to establish a longitudinally secured connection.

### CLAIM OF PRIORITY

This patent application is continuation of U.S. Non-provisional application Ser. No. 17/907,705, filed on Sep. 29, 2022, which application was a U.S. National Stage Filing under 35 U.S.C. 371 from International Application No. PCT/US2021/070488, filed on Apr. 30, 2021, which claims the benefit of U.S. Provisional Pat. Application No. 63/019,366, filed May 3, 2020, each of which are incorporated by reference herein in their entireties.

### FIELD OF THE INVENTION

The present disclosure relates to tool connections. In particular, the present disclosure relates to automated tool exchange devices and systems. More particularly, the present disclosure relates to a passive connection and disconnection system for attaching tools to a tool arm.

### BACKGROUND OF THE INVENTION

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Many pipe handling operations, such as drill pipe handling operations, are conventionally performed with workers performing manual operations. For example, drilling of wells involves tripping of the drill string, during which drill pipes are lowered into (tripping in) or pulled out of (tripping out) a well. Tripping may typically occur in order to change all or a portion of the bottom hole assembly, such as to change a drill bit. Where drill pipe is tripped into a well, stands or lengths of drill pipe may be supplied from a storage position in a setback area of the drill rig and connected end-to-end to lengthen the drill string in the well. Where drill pipe is tripped out of a well, stands or lengths of drill pipe may be disconnected from the drill string and may be positioned in the setback area.

As with other pipe handling operations, tripping has conventionally been performed with human operators. In particular, while an elevator or top drive may be used to carry the load of a stand of drill pipe during trip in and trip out operations, human operators may typically maneuver the drill pipe stands around the drill floor, such as between the well center and the setback area. For example, a first human operator may be positioned on the drill floor, at or near the well, to maneuver a lower end of drill pipe stands as they are tripped into or out of the well, while a second human operator may be positioned on or above the racking board to maneuver an upper end of drill pipe stands as the stands are moved between the well and the setback area. Operators often use ropes and/or other tools to maneuver the drill pipe stands on or above the drill floor. Such work is labor-intensive and can be dangerous. Moreover, trip in and trip out operations may be limited by the speed at which the human operators can maneuver the stands between well center and the setback area.

Robotic pipe handling systems may be used to handle pipe to assist with and/or perform the above pipe handling operations on a drill rig. The robots may include a series of links that are hingedly and/or pivotally connected to one another and reach to an end effector. While helpful to have a robot to assist with pipe handling, the end effector may be adapted for a particular purpose or use and may limit the versatility of the robot. Moreover, electrical, hydraulic, or other power may not be desirable to aid in engaging/disengaging particular end effectors or tools. That is, while a robot may have power for moving the robot, particular actuation power for coupling and decoupling tools may not be present or desirable in the robotic environment or in other environments.

### BRIEF SUMMARY OF THE INVENTION

The following presents a simplified summary of one or more embodiments of the present disclosure in order to provide a basic understanding of such embodiments. This summary is not an extensive overview of all contemplated embodiments and is intended to neither identify key or critical elements of all embodiments, nor delineate the scope of any or all embodiments.

In one or more embodiment, a coupling mechanism for securing a tool to a tool arm may include a housing. The mechanism may also include an engaging lock arranged within the housing and configured for rotation by the tool arm. Rotation of the engaging lock may drive locking mechanisms partially through the housing to establish a longitudinally secured connection.

In one or more embodiments, a method of interchanging an end effector may include engaging a tool portion of a coupling mechanism with a proximal portion. The tool portion may be arranged in a fixture and held against rotation and horizontal translation. The method may include rotating the proximal portion to activate an engaging lock and lifting the tool portion from the fixture. The method may also include engaging a relative rotation lock by the lifting.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a robot with a coupling mechanism, according to one or more embodiments.

FIG. 2 is an exploded view of the coupling mechanism of FIG. 1.

FIG. 3 is a back perspective view of a tool portion of a coupling mechanism with an end effector and arranged in a fixture, according to one or more embodiments.

FIG. 4 is a front perspective view of a tool portion of a coupling mechanism with an end effector and arranged in a fixture, according to one or more embodiments.

FIG. 5 is front perspective view of a tool portion of a coupling mechanism, according to one or more embodiments.

FIG. 6 is a front perspective exploded view thereof.

FIG. 7 is a back perspective exploded view thereof.

FIG. 8 is a perspective view of an engaging lock of the coupling mechanism, according to one or more embodiments.

FIG. 9 is a front view of the engaging lock of FIG. 8.

FIG. 10 is a rear perspective view of the tool portion of the coupling mechanism of FIG. 2, arranged in a fixture and having a portion removed to allow the external relative rotation lock system to be viewed, according to one or more embodiments.

FIG. 11 is a rear perspective view thereof showing the external relative rotation lock system and the fixture, according to one or more embodiments.

FIG. 12 is a perspective view of another coupling mechanism, according to one or more embodiments.

FIG. 13 is a perspective view of a tool portion of the coupling mechanism of FIG. 12 arranged in a fixture, according to one or more embodiments.

FIG. 14 is a perspective view of the tool portion of the coupling mechanism of FIG. 12, according to one or more embodiments.

FIG. 15 is an exploded view thereof.

FIG. 16 is an additional exploded view thereof.

FIG. 17 is a perspective view of an engaging lock of the tool portion of the coupling mechanism of FIG. 12, according to one or more embodiments.

FIG. 18 is a back side break away view of the tool portion arranged in the fixture showing the lock control flaps a releasing position, according to one or more embodiments.

FIG. 19 is a back side break away view of the tool portion removed from the fixture showing the lock control flaps in a holding position, according to one or more embodiments.

FIG. 20 is a perspective view of a fixture for the coupling mechanism of FIG. 12, according to one or more embodiments.

FIG. 21 is another perspective view of the fixture of FIG. 21, according to one or more embodiments.

FIG. 22A is a method diagram depicting a method of engaging a tool, according to one or more embodiments.

FIG. 22B is a method diagram depicting a method of disengaging a tool, according to one or more embodiments.

FIG. 23A is a method diagram depicting a method of engaging a tool, according to one or more embodiments.

FIG. 23B is a method diagram depicting a method of disengaging a tool, according to one or more embodiments.

FIG. 24 is a side view of a drill rig having a drill pipe handling system of the present disclosure, according to one or more embodiments.

FIG. 25 is an overhead view of a racking board of the present disclosure, according to one or more embodiments.

FIG. 26 is a close-up side view of a traveling block and a pipe elevator of the present disclosure, according to one or more embodiments.

FIG. 27A is a side view of a pipe handling robot of the present disclosure arranged on a drill floor, according to one or more embodiments.

FIG. 27B is another side view of the pipe handling robot of FIG. 27A, according to one or more embodiments.

FIG. 28A is a perspective view of a pipe handling robot of the present disclosure arranged on a racking board, according to one or more embodiments.

FIG. 28B is another side view of the pipe handling robot of FIG. 28A, according to one or more embodiments.

FIG. 29 is a close-up view of an end effector of a pipe handling robot of the present disclosure, according to one or more embodiments.

FIG. 30A is a side view of an end effector of the present disclosure approaching a pipe stand in an open position, according to one or more embodiments.

FIG. 30B is a side view of the end effector of FIG. 30A in a closed position around the pipe stand, according to one or more embodiments.

FIG. 31 is a flow diagram of a trip-out operation of the present disclosure, according to one or more embodiments.

FIG. 32A is a side view of a drilling rig having a pipe handling system of the present disclosure with a pipe stand engaged by a pipe elevator, according to one or more embodiments.

FIG. 32B is a side view of the drilling rig of FIG. 32A with a first pipe handling robot engaging with a lower end of the pipe stand, according to one or more embodiments.

FIG. 32C is an overhead view of the drill floor of the drilling rig of FIG. 32A with the first robot engaging with a lower end of the pipe stand, according to one or more embodiments.

FIG. 32D is a side view of the drilling rig of FIG. 32A with the first robot maneuvering the lower end of the pipe stand toward a setback area of the drill floor, according to one or more embodiments.

FIG. 32E is a side view of the drilling rig of FIG. 32A with a second pipe handling robot engaging with an upper end of the pipe stand, according to one or more embodiments.

FIG. 32F is an overhead view of the racking board of the drilling rig of FIG. 32A, with the second robot maneuvering the upper end of the pipe stand toward a racking location, according to one or more embodiments.

FIG. 32G is a side view of the drilling rig of FIG. 32A with the second robot maneuvering the upper end of the pipe stand toward a racking location, according to one or more embodiments.

FIG. 32H is a side view of the drilling rig of FIG. 32A with the pipe elevator lowered toward the drill floor and the first robot disengaged from the pipe stand, according to one or more embodiments.

FIG. 33 is a flow diagram of a trip-in operation of the present disclosure, according to one or more embodiments.

FIG. 34 is a diagram of a pipe handling system of the present disclosure, according to one or more embodiments.

FIGS. 35A-35C are a flow diagram of a lifting system state machine for a trip in operation of the present disclosure, according to one or more embodiments.

FIGS. 36A-36B are a flow diagram of an upper robot state machine for a trip in operation of the present disclosure, according to one or more embodiments.

FIGS. 37A-37B are a flow diagram of a lower robot state machine for a trip in operation of the present disclosure, according to one or more embodiments.

FIGS. 38A-38B are a flow diagram of an iron roughneck state machine for a trip in operation of the present disclosure, according to one or more embodiments.

FIGS. 39A-39D are a flow diagram of a trip in operation performable by a pipe handling system of the present disclosure, according to one or more embodiments.

FIG. 40A is a perspective view of a pipe handling robot of the present disclosure engaging with a pipe stand at well center, according to one or more embodiments.

FIG. 40B is a perspective view of the pipe handling robot of FIG. 40A positioning a pipe stand on a first side of a drill floor, according to one or more embodiments.

FIG. 41A is a perspective view of a pipe handling robot of the present disclosure engaging with a pipe stand at well center, according to one or more embodiments.

FIG. 41B is a perspective view of the pipe handling robot of FIG. 41A positioning a pipe stand on a second side of a drill floor, according to one or more embodiments.

### DETAILED DESCRIPTION

The present disclosure, in one or more embodiments, relates to devices, systems, and methods for passively connecting/disconnecting a tool to/from a tool arm. In particular, a coupling mechanism may be provided that allows for interchanging end effectors or other tools without the use of hydraulic, pressurized air, electrical, or other type of power to engage/disengage a coupling mechanism. Rather rotation of one portion of the coupling mechanism relative to another portion may be sufficient to engage the two parts of the coupling mechanism. In one or more embodiments, the passive coupling mechanism may be coupled and decoupled by engaging an end effector or other tool positioned in a fixture with a portion of the coupling mechanism and rotating that portion of the coupling mechanism. This may occur by rotating a tool arm, for example, or rotating a wrist portion of a robot. In the case of tubular handling, the end effector may be lifted from the fixture and used to handle tubulars on a drill rig, for example. To replace the end effector in the fixture, the robot or user may cause the end effector to engage the fixture and rotation may, again, be used to uncouple the end effector from control by the tool arm or robot allowing for the end effector to be left behind in the fixture for later use. The coupling mechanism may, thus, provide for a secured connection of an end effector to a tool arm or robot that allows for interchangeability of end effectors or other tools without reliance on power to actuate the coupling mechanism, for example.

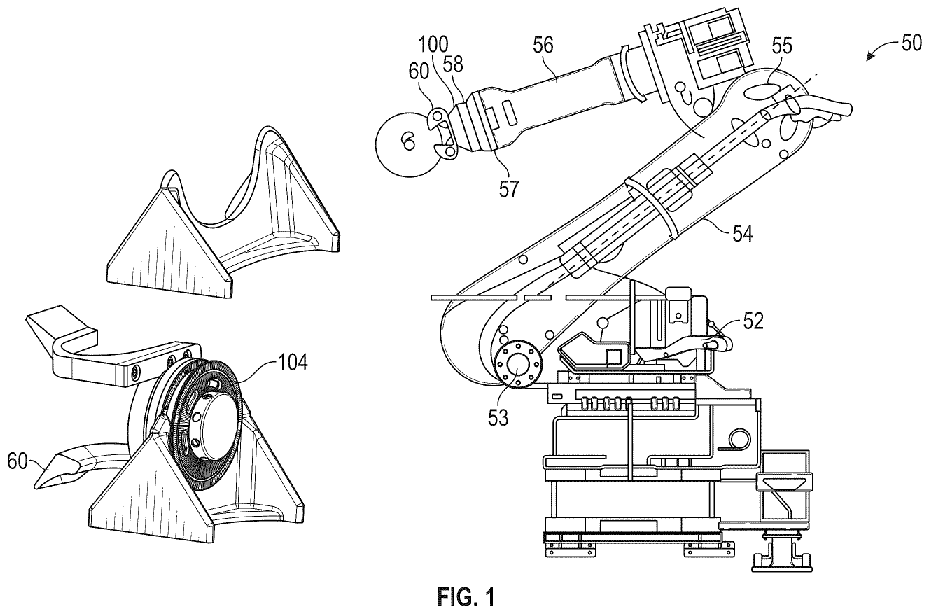

Referring now to FIG. 1, a robot is shown in use and near a pair of fixtures. The fixtures may define a setting or holding location for end effectors or other robot tools. As shown, one of the fixtures is empty and the other fixture is holding an end effector. Another end effector is arranged on the robot. The present application may provide a mechanism for placing the end effector on the robot on an empty fixture, releasing the end effector, and engaging and coupling to another available end effector. As such, the versatility of the robot may be increased.

With continued reference to FIG. 1, a pipe handling robot 50 of the present disclosure is shown, according to one or more embodiments. The pipe handling robot 50 may be configured to manipulate tubulars such as lengths of pipe including, drilling pipe or drill collar. In some embodiments, the pipe handling robot 50 may be configured for manipulating stands of drill pipe, each stand comprising one, two, three, four, five, or any other suitable number of pipe lengths or sections. The robot 50 may be manually operable and/or may be programmable. That is, while the operative portion of the system may be described as being a robot 50, the coupling mechanism described herein may be used in other contexts as well where a tool is being attached to an arm, for example. That is, nothing in this disclosure shall limit the use of the coupling mechanism to a robot environment. The coupling mechanism may, for example, be applicable to hand tools and other systems where tools may be interchanged. For example, socket sets, air compressor tools, or other interchangeable tool environments. Where a robot is provided, in some embodiments, the robot 50 may be programmable with a finite state machine or other programming configured to perform a sequence of operations. As shown in FIG. 1, the robot 50 may include a base portion 52, a shoulder portion 54, an articulated arm 56, a wrist portion 58, and an end effector 60. The end effector may be coupled to the wrist portion with a coupling mechanism 100.

The base portion 52 may be configured to couple or fix the robot 100 to a surface, from which the robot may extend to perform operations. In some embodiments, the base portion 52 may provide a means of moving the robot 50 with respect to the surface from which it extends or is otherwise arranged or affixed. For example, the base portion 52 may have skids or rollers configured for sliding engagement with a track or rail. In other embodiments, the base portion 52 may have other movement means for moving the robot 50, such as wheels, treads, a walking mechanism, or other suitable movement means. In one or more embodiments, the base portion may be secured to a drill floor of a drill rig or it may be secured to framing at or near a racking board, for example.

The shoulder portion 54 may couple, at a proximal end of the shoulder portion, to the base portion 52. The shoulder portion 54 may couple to the base portion 52 via a joint 53, which may be or include a swivel joint in some embodiments. The swivel joint 53 may allow the shoulder portion 54 to twist or rotate about a central axis with respect to the base portion 52. In other embodiments, the shoulder portion 54 may couple to the base portion 52 with a different joint, or the shoulder may couple to the base portion without a joint. The shoulder portion 54 may extend from the base portion 52 at an angle, such that a longitudinal axis of the shoulder portion may be offset from a longitudinal axis of the base portion by approximately 10-45 degrees, or any other suitable degree of offset. The shoulder portion 54 may have a length ranging from approximately 12 inches to approximately 100 inches.

The articulated arm 56 may couple to the shoulder portion 54 at a distal end of the shoulder portion and a proximal end of the articulated arm. A joint or elbow 55, which may be or include a pitch joint, may be arranged between the articulated arm 56 and shoulder portion 54. The pitch joint 55 may allow the articulated arm 56 to pivot with respect to the shoulder portion 54 about an axis extending lateral to the shoulder portion and articulated arm. In some embodiments, the pitch joint 55 may allow the articulated arm 56 to pivot within a range of up to 360 degrees of rotation. In other embodiments, the articulated arm 56 may couple to the shoulder portion 54 via a different joint or without a jointed connection. The articulated arm 56 may have a length of between approximately 20 inches and approximately 100 inches.

The wrist 58 may couple to the articulated arm 56 at a distal end of the articulated arm and a proximal end of the wrist. A joint 57 may be arranged between the wrist portion 58 and the articulated arm 56 and may provide for pivotable or rotational movement of the wrist with respect to the articulated arm about one or more axes. The joint 57 may be or include a pitch joint allowing for pivotable movement about a first lateral axis extending lateral to the articulated arm 56 and wrist 58, a yaw joint allowing for pivotable movement about a second lateral axis perpendicular to the first lateral axis, and/or a roll joint allowing for pivotable or rotational movement about an axis extending longitudinally through the wrist portion. The wrist portion 58 may have pivotable or rotational movement about each axis within a range of up to 360 degrees of rotation. In other embodiments, the wrist portion 58 may couple to the articulated arm 56 via a different joint or without a jointed connection. The wrist 58 may be configured to provide a mechanical interface or mounting point for coupling an end effector 60 to the robot 50. In some embodiments, still another joint, such as a pitch, yaw, and/or roll joint, may allow for pivotable movement of the end effector 60 with respect to the wrist portion 58. In some embodiments, the robot may have a mechanism, which may be a self-contained actuator mechanism that is electrically or hydraulically actuated, for example, configured to rotate or pivot the end effector. The actuator mechanism may be independent from axis controls for the articulated arm and/or other arm movement controls.

The end effector 60 may extend from a distal end of the wrist portion 58 and may be configured to provide an operational or tooling hand for various operations performed by the robot 50. While not discussed in detail herein, end effectors or robot tools may be provided in a variety of forms. For example, end effectors or robot tools may be provided as shown and described in International Patent Application No. PCT/US2019/044976 filed on Aug. 2, 2019 and entitled End Effectors for Automated Pipe Handling, the content of which is hereby incorporated by reference herein in its entirety. Still other non-robotic end effectors may be provided such as sockets, air tools, or other tools.

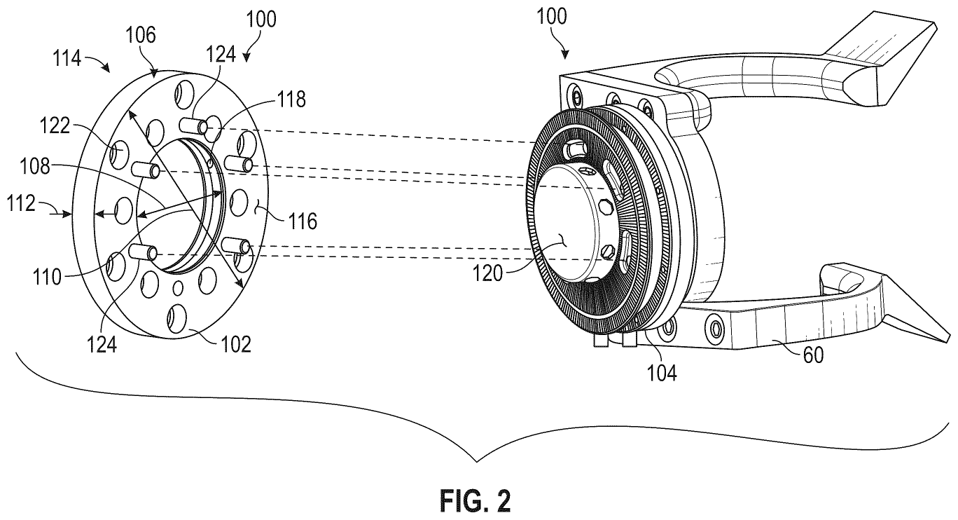

As mentioned, end effector interchangeability may be provided by a coupling mechanism 100. As shown in FIG. 2, the coupling mechanism 100 may include a robot or proximal portion 102 and a tool portion 104. The proximal portion 102 may be affixed to the wrist 58 of the robot 50, for example, or it may be affixed to a tool arm air hose, or other operable element. The tool portion 104 may be arranged on an end effector or other tool 60 and may be adapted for selective engagement by the proximal portion 102. As mentioned, while the present coupling mechanism 100 is being described in the context of a robotic environment, still other uses may be provided. As such, by referring to one portion of the coupling mechanism 100 as a robot or proximal portion 102, the term or phrase controlled portion or arm portion is to be considered equally applicable. That is, the robot or proximal portion 102 should not be considered to necessarily implicate the presence of a robot. For this purpose, the robot or proximal portion will be referred to hereafter as proximal portion.

With continued reference to FIG. 2, the proximal portion 102 may be configured to selectively engage the tool portion 104 of the coupling mechanism 100. The proximal portion may include a body portion 106 adapted for attachment to the robot 50, tool arm, or other actuating or controlling device. The body portion 106 may include a plate or other shape adapted for placement against and attachment to the wrist 58 of the robot 50 or the plate of a tool arm, for example. In one or more embodiments, the body portion 106 may include an annularly shaped plate with an outer diameter 110, an inner diameter 108, and a thickness 112. The outer diameter 110 may be selected to be the same, slightly smaller, and/or slightly larger than the wrist 58 and the inner diameter 108 may be selected to receive a coupling plug of the tool portion 104. The thickness may be selected to receive the coupling plug 120 of the tool portion 104 and to allow for engagement with the coupling plug 120 on an inner surface thereof. The body portion may include a back face 114 adapted for securing against the wrist of the robot or tool arm and a front face 116 adapted for engaging the tool portion 104 of the coupling mechanism 100. The thickness 112 of the body portion 106 may define an outside wall and inside wall. The outside wall may be arranged along the outside diameter and may extend from the back face to the front face forming a substantially cylindrical outer surface. Similarly, the inside wall may be arranged along the inside diameter and may extend from the back face to the front face. The inside wall may include a groove 118 extending along the length of the inside wall. The groove 118 may be adapted to receive a ball from the coupling plug of the tool portion 104 to cause the proximal portion 102 and the tool portion 104 to lockingly engage.

In one or more embodiments, the body portion 106 may include a plurality of bores 122 extending through the body portion from the front face to the back face and adapted to receive fasteners to secure the body portion to the wrist of the robot or other operating device or element, for example. The body portion 106 may also include a plurality of protruding engagement features 124 extending from the front face 116 and adapted to engage with the tool portion 104 and trigger a locking mechanism. In one or more embodiments, the protruding engagement features 124 may include a plurality of dowels arranged along a circle having a diameter between the inner and outer diameters of the body portion 106. In one or more embodiments, the front face 116 may be a substantially flat face and the dowels may extend substantially perpendicular to the front face 116. The dowels may be spaced along the circle so as to engage openings in the tool portion 104. The dowels may be adapted to unlock the particular features of the tool portion to allow the tool portion to be coupled to the proximal portion 102 and to free the tool portion from its fixture.

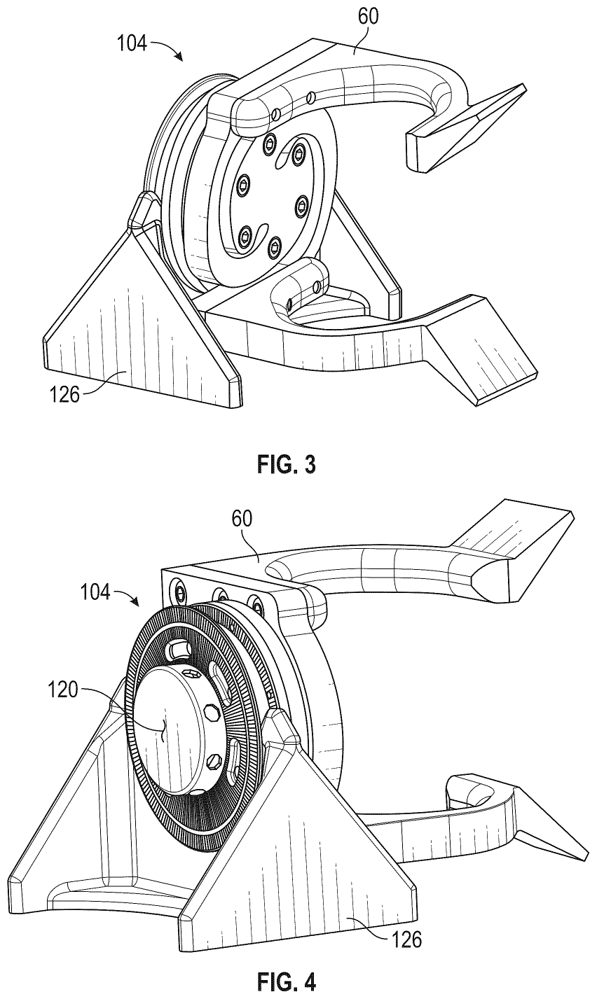

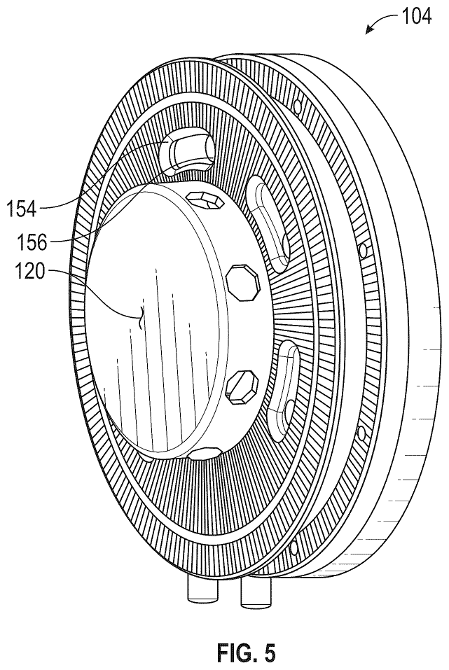

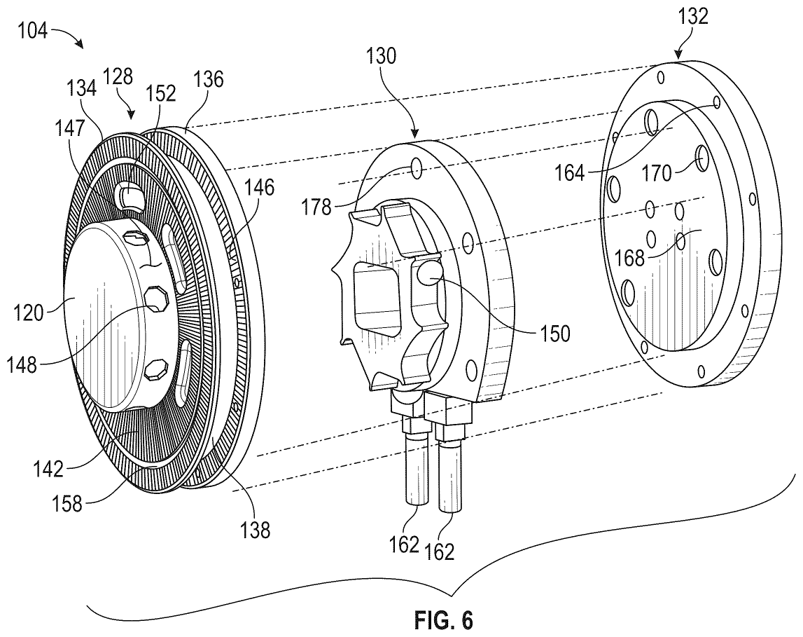

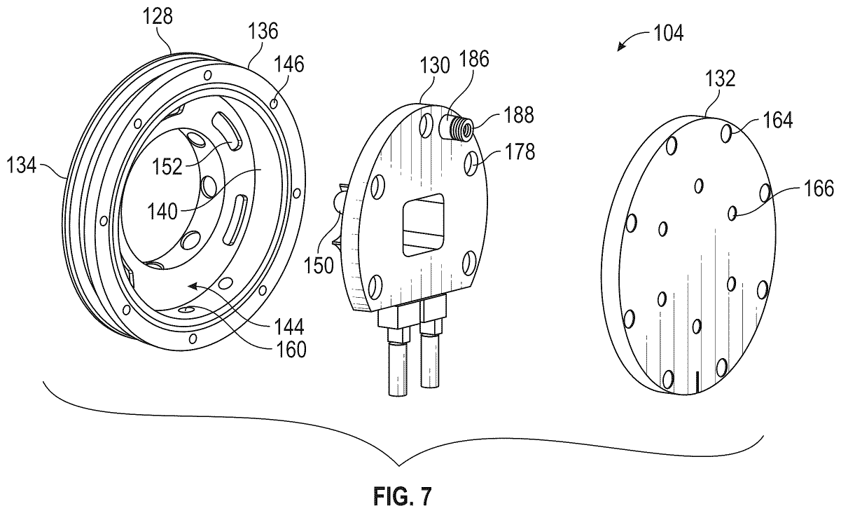

The tool portion 104 is shown in FIGS. 3 and 4 arranged in a fixture 126 and having an end effector 60 secured thereto. The tool portion 104 may be configured for resting in a fixture 126 as shown and for being resistant to rotation in the fixture 126. The tool portion 104 may be adapted for engagement by a robot or tool arm in the fixture 126 and lifting from the fixture by the robot or tool arm. The tool portion 104 may also be adapted to couple with the proximal portion in secure fashion to withstand the pushing and pulling forces generated from operations of the robot or other operating device. In one or more embodiments, the tool portion may be adapted to couple with the proximal portion to withstand forces generated from the end effector handling tubulars. FIG. 5 shows a perspective view of the tool portion 104 and FIGS. 6 and 7 show perspective exploded front and back views, respectively, of the tool portion 104. As shown, the tool portion 104 may include an interfacing housing 128, an engaging lock 130, an end effector interface 132, and one or more relative rotation lock systems may be provided.

The interfacing housing 128 is shown in FIGS. 6 and 7. The interfacing housing 128 may be adapted to engage with the proximal portion 102 of the coupling mechanism 100 as well as the fixture 126. As shown, the interfacing housing 128 may include a front engagement plate 134 and a back engagement plate 136. The front and back engagement plates 134/136_may be annularly shaped and spaced apart from one another defining a circumferential groove or slot 138 along an outer peripheral edge thereof. The groove or slot 138 may be adapted to receive the fixture 126 allowing the interfacing housing 128 to nestingly rest on the fixture 126. The front engagement plate 134 and the back engagement plate 136 may extend radially outward from a central cylindrical shell 140 to an outer peripheral edge. The central cylindrical shell 140 may define the bottom of the groove or slot 138 and may be sized and shaped to substantially match a radiused seat of the fixture 126. The front engagement plate 134 may also extend radially inward from the central cylindrical shell 140 defining a front surface 142 that is larger than a back surface of the back engagement plate. Together, the front engagement plate 134, the central cylindrical shell 140 and the back engagement plate 136 may define an internal cavity 144. As shown, the back engagement plate 136 may include a plurality of openings 146 each for receiving a fastener to connect the interfacing housing to the end effector interface 132. Each of the front engagement plate 134 and the back engagement plate 136 may have substantially smooth surfaces or a radiating line surface pattern may be provided as shown. Still other surface patterns may be provided or used.

The interfacing housing 128 may also include a hub or plug 120 extending longitudinally from an inner radial edge of the front engagement plate 134. The hub or plug 120 may be sized and shaped to engage the body portion 106 of the proximal portion 102 of the coupling mechanism 100. That is, the hub or plug 120 may have a diameter selected to be slightly smaller than the inner diameter of the annularly shaped body portion 106 of the proximal portion 102, for example. The hub or plug 120 may also extend from the front engagement plate 134 by a distance similar to the thickness or slightly less than the thickness 112 of the body portion 106 of the proximal portion 102. The hub or plug 120 may have a cylindrical sidewall 147 including a plurality of openings 148 spaced along the periphery of the hub or plug 120 and extending through the sidewall 146. The openings 148 may be sized and shaped to allow actuated catches 150 to extend partially therethrough so as to engage the groove 118 on the inside wall of the body portion 106 of the proximal portion 102 of the coupling mechanism 100. That is, for example, the openings 148 may have a diameter slightly smaller than an engagement ball such that the ball may extend partially through the opening 148 and seat in the groove 118 of the proximal portion 102, but the opening 148 may prevent full exit of the ball.

As shown, the interfacing housing 128 may include a plurality of circumferentially extending slots 152 extending through the front engagement plate 134. The slots 152 may be adapted to receive the dowels 124 from the proximal portion 102 and, as such, may be arranged on a diameter that is the same or similar to the diameter of the circle on which the dowels 124 of the proximal portion 102 are arranged. The diameter of the circle may be, for example, smaller than the diameter of the central cylindrical shell. The slots 152 may be kidney shaped, for example, so as to allow for rotation of the dowels 124 relative to the front engagement plate 134 after the dowels 124 are inserted into the slots 152. The dowels may be used to actuate the engaging lock 130 by insertion through the slots 152 and rotating relative to the front engagement plate 134. Referring to FIG. 5, in one or more embodiments, the kidney shaped slots may have an initial engagement end 154 and a locking end 156. That is, the dowels 124 from the proximal portion 102 may be inserted into the slots 152 at an initial engagement end 154 and then the dowels 124 may be rotated to a locking end 156 of the slots 152.

The front engagement plate 134 may also include a circumferentially extending groove 158 on a front surface thereof at a radial dimension beyond the slots 152. The groove 158 may be adapted for receiving a seal or O-ring, for example, to allow the interfacing housing 134 to seal against the front face 116 of the body 106 of the proximal portion 102.

As best shown in FIG. 7, the interfacing housing 134 may include one or more openings 160 extending through the central cylindrical shell 140. The openings 160 may be arranged in the groove 138 between the front and back engagement plates 134/136 and may be adapted to allow fixture dowels 162 to pass therethrough to rotationally secure the tool portion 104 to the fixture 126. In one or more embodiments, the openings 160 may be arranged through a bottom portion of the shell 140. In other embodiments, other positions may be used.

The end effector interface 132 may be arranged on an end of the tool portion 104 opposite the interfacing housing 128 and may provide a backing and attachment surface for the housing 128. The end effector interface 132 may include a substantially plate-like element having a circumferential bore circle near an outer peripheral edge. The bore circle may have a diameter that is the same or similar to the diameter of the openings 146 on the back engagement plate 136 of the interfacing housing 128 and a plurality of bores 164 may be spaced along the bore circle to align with the openings on the back engagement plate 136. The back of the end effector interface 132 may include a plurality of bores 166 for securing an end effector 60. The bores 166 may be threaded bores for bolting an end effector 60 thereto, for example.

The end effector interface 132 may also include a raised surface 168 on a front side thereof. The raised surface 168 may be circular and adapted to nest within the cavity 144 of the interfacing housing 128 while leaving room for the engaging lock 130. As shown, the raised surface 168 may include a plurality of bores 170 extending therethrough. The bores 170 may be arranged on a bore circle having a diameter that is the same or similar to the diameter of the circumferentially extending slots 152 on the front engagement plate 134. The plurality of bores 170 may be arranged along the bore circle and the bores may be spaced such that each bore may align with a portion of one of the kidney-shaped slots 152 of the front engagement plate 134. The bores 170 may function to hold a relative rotation lock adapted to prevent inadvertent rotation of the engaging lock 130 as described in more detail below.

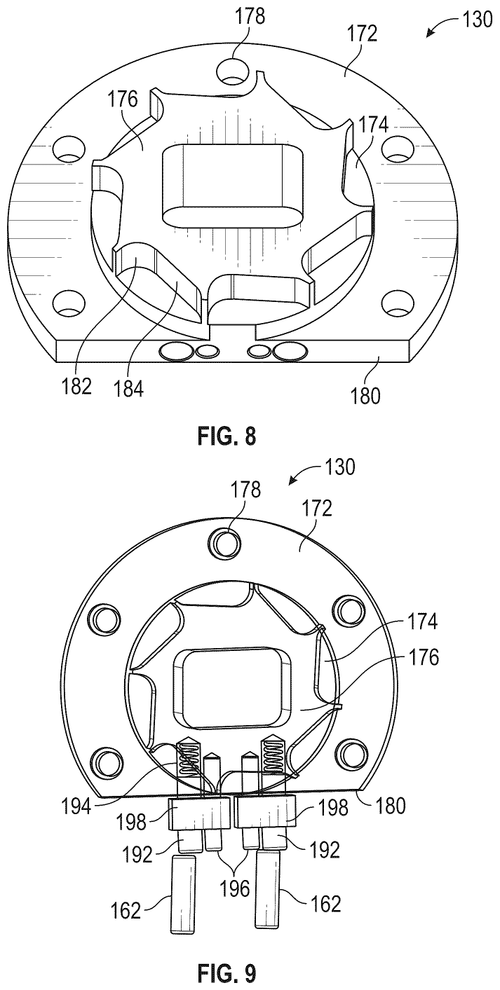

The engaging lock 130 is also shown in FIGS. 6 and 7. As shown, the lock 130 is sized and adapted to fit within the cavity 144 of the interfacing housing 128 between the front engagement plate 134 thereof and the end effector interface 132. The engaging lock 130 may be configured for rotation within the cavity 144 to cause the tool portion 104 of the coupling mechanism 100 to lockingly engage the proximal portion 102. In particular, the engaging lock 130 may rotate to drive locking balls 150 outward through the openings 148 in the cylindrical sidewall of the hub 120 of the interfacing housing 128. The balls 150 may engage the groove 118 on the inside wall of the body 106 of the proximal portion 102 of the coupling mechanism 100 thereby preventing relative longitudinal motion of the two parts. As shown in FIGS. 8 and 9, the engaging lock 130 may include a rotational guide 172, an offsetting platform 174, and a lock actuator 176.

The rotational guide 172 may be a substantially plate-like element with a circular profile sized to fit within and rotate within the central cylindrical shell 140. The rotational guide 172 may include a plurality of bores 178 extending therethrough. The bores 178 may be on a bore circle matching that of the circumferentially extending slots 152 on the front plate 134 of the interfacing housing 128. As shown when comparing FIG. 6 to FIG. 7, the bores 178 may have a first diameter for receiving the dowels 124 from the proximal portion 102 and a second diameter for receiving pins of the relative rotation lock (i.e., pins arranged in the bores of the raised surface of the end effector interface). The second diameter may be larger than the first diameter and the transition from one bore size to the other may occur at a point along the length of the bore 178 extending through the rotational guide 172. The rotational guide 172 may also include a flattened side 180. As shown best in FIG. 8, the flattened side 180 may extend across the rotational guide 172 forming a circle segment that is substantially flush with the outside peripheral surface of the offsetting platform 174, for example. As shown in FIG. 9, the flattened side 180 may include one or more pin bores extending into the flattened side for receiving pins for a relative rotation lock for the fixture.

The offsetting platform 174 may be a circular raised surface extending longitudinally forward from the rotational guide 172. The offsetting platform 174 may help to position the lock actuator 176 within the hub or plug 120 of the interfacing housing 128 by reaching through the thickness of the front engagement plate 134 to position the lock actuator 176 therein.

The lock actuator 176 may be arranged on the offsetting platform 174. The lock actuator 176 may be configured for driving balls or other locking mechanisms 150 through the openings 148 of the hub or plug 120 on the interfacing housing 128 such that the balls or other locking mechanisms 150 engage the groove 118 on the proximal portion 102 of the coupling mechanism 100. As shown in FIGS. 6, 8, and 9, the lock actuator 176 may be generally star shaped when viewed from the front. That is, for example, the lock actuator 176 may have a thickness and outer diameter similar to the thickness of the hub or plug 120 on the interfacing housing such that the lock actuator 176 fits within the hub or plug 120. The peripheral surface of the lock actuator 176 may be defined by a plurality of sockets 182 having sloping ramps 184 extending therefrom. For example as shown in FIGS. 8 and 9, a curved ball socket 182 may be formed on a counterclockwise side of each star blade and a ramp 184 may extend further counterclockwise from the ball socket 182 generally linearly to the outer surface of the lock actuator 176 at a location substantially flush with the outer diameter of the offsetting platform 174.

In operation, the engaging lock 130 may function to secure the proximal portion 102 and the tool portion 104 to one another. For example, a ball 150 may rest in the ball socket 182 and be held in that position by partial engagement with the openings 148 in the hub 120 of the interfacing housing 128. In this position the engaging lock 176 may be unlocked (e.g., the balls are recessed within the openings 148 in the hub 120). The engaging lock 130 may rotate clockwise within the interfacing housing 128 relative to the housing 128 and relative to the ball 150, the ball 150 being held in place by the openings 148 in the hub 120. As the engaging lock 130 rotates clockwise, the ramps 184 on the outer surface of the lock actuator thereof may drive the ball 150 radially outward and partially through the openings 148 in the sidewall 146 of the hub 120. In this position, the lock actuator 130 may be locked (e.g., the balls 150 are driven radially outward to engage the groove 118 in the proximal portion 102 of the coupling mechanism 100).

Without more, the engaging lock 130 may rotate relatively freely at least between an unlocked position and a locked position. For purposes of restricting free motion of the lock actuator 130 and controlling alignment of the lock actuator 130 with other components, one or more relative rotation lock systems may be provided.

The first relative rotation lock system may be arranged between the lock actuator 130 and the end effector interface 132 and may control the relative rotation between the lock actuator 130 and other portions of the tool portion 104 of the coupling mechanism 100 and may be deemed an internal system. A second relative rotation lock system may be arranged between the tool portion 104 of the coupling mechanism 100 and the fixture 126 and may be deemed an external system.

With respect to the internal system, reference is made to FIGS. 6 and 7. As shown, an internal system may include a bias pin 186 configured to engage the back side of the engaging lock 130. That is, biased pins 186 may be arranged in the bores 170 on the raised portion 168 of the end effector interface 132. The pins 186 may be biased in a direction out of the bore 170 and in a direction toward the engaging lock 130 by a spring or other biasing mechanism 188. When the biased pins 186 are arranged in alignment with the bores 178 extending through the engaging lock 130 (e.g., when the tool portion 104 is positioned in the fixture 126), the pins 186 may advance into the bores 178 to a point where the bore narrows and the pins 186 may seat themselves partially in the bore 178 of the engaging lock 130 and partially in the bore 170 of the end effector interface 132. The pin 186 being partially arranged in each bore 170/178 may prevent relative rotation between the two elements. As such, in this condition, the engaging lock 130 may not rotate relative to the other portions of the tool portion 104 of the coupling mechanism 100. This may help to ensure that the engaging lock 130 is in a proper position when approached by a robot or tool arm for coupling, for example.

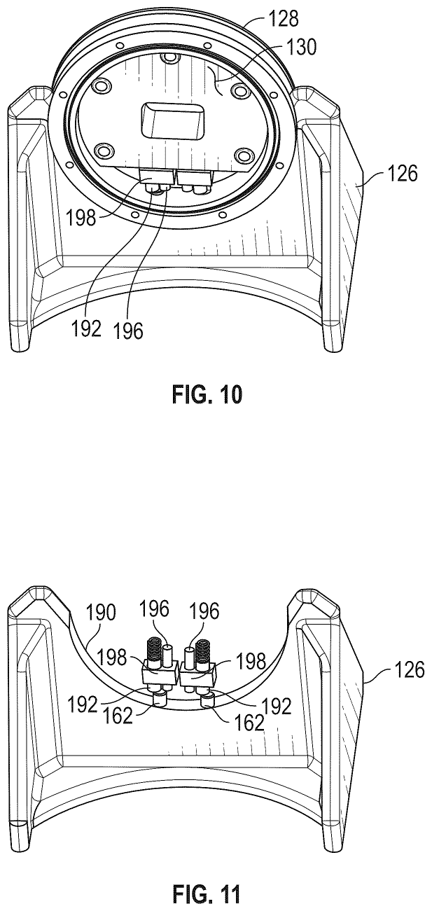

With respect to the external system, reference is made to FIGS. 9-11. As best shown in FIG. 11, the fixture 128 may include a saddle 190 for receiving the tool portion 104 of the coupling mechanism 100. The saddle 190 may be sized and curved to provide for seating of the tool portion 104 of the coupling mechanism 100 by engagement with the groove or slot 138 on the outer peripheral surface of the interfacing housing 128. For example, a radiused or otherwise curved saddle 190 may be provided as shown. Alternatively, a rectangular or square saddle 190 may be provided. In still other embodiments, vertically extending bars or rods spaced from one another to allow the tool portion to slip between them may be provided and a separate chair, table, or stand may be provided between them that functions to engage the openings in the groove of the coupling mechanism. Still other saddle shapes may be provided. As shown, the fixture 126 may include one or more pins or dowels 162 extending upward and radially inward from the saddle. The pin or dowel 162 may be adapted to engage the openings 160 on the groove 138 to prevent relative rotation of the tool portion 104 when the tool portion 104 is seated in the fixture 126. This may allow for stationary positioning of the tool portion 104 such that the robot or tool arm may release or engage the tool without translation or rotation.

Thus far, we have discussed preventing relative rotation of the internal engaging lock 130 and relative rotation of the tool portion 104 when the tool is positioned in the fixture 126. For purposes of resisting or preventing rotation when the tool is in use, one or more biased locking pins 192 may be arranged within the interfacing housing 128 between the groove 138 and the engaging lock 130 arranged therein. When the tool portion 104 is engaged by the proximal portion 102, the biased locking pins 192 may be arranged in line with the openings 160 in the groove 138 of the interfacing housing 128 and the biased nature of the pins 192 may cause them to extend through the openings 160 in the groove 138. The position of the pins 192 in the engaging lock 130 and through the interfacing housing 128 may prevent relative rotation of the engaging lock 130 and the interfacing housing 128 during use.

More particularly, as shown in FIG. 9, a biased locking pin 192 may be arranged in a bore 194 in the bottom of the engaging lock 130. As shown, two biased locking pins 192 are shown. The pin 192 may function to extend through the openings 160 in the groove 138 of the interfacing housing 128 when the engaging lock 130 is rotated clockwise and the tool portion 104 is not in the fixture 126. In addition, a guide pin 196 and block 198 may be provided to assist with maintaining alignment of the locking pin 192. That is, for example, a block 198 may be secured to the locking pin 192. The block 198 may include a sleeve bore therethrough that is parallel to the locking pin 192. A guide pin 196 may be secured to the engaging lock 130 adjacent and parallel to the locking pin 192 and extending out of the bottom of the engaging lock 130. The guide pin 196 may extend through the sleeve bore in a sliding engagement such that the block 198 and locking pin 192 may travel together along the guide pin 196 in an aligned fashion. In addition to guiding the travel of the locking pin 192, the block 198 may also function as a stop to hold the biased locking pin 192 from extending too far through the openings 160 and/or from falling out. That is, the block 198 may engage the inner surface of the groove 138 of the interfacing housing 128, for example, to prevent excessive travel of the locking pin 192. Alternatively or additionally, a biased locking pin 192 with a wider head may be provided. A constraining housing around the locking pin 192 may also be provided.

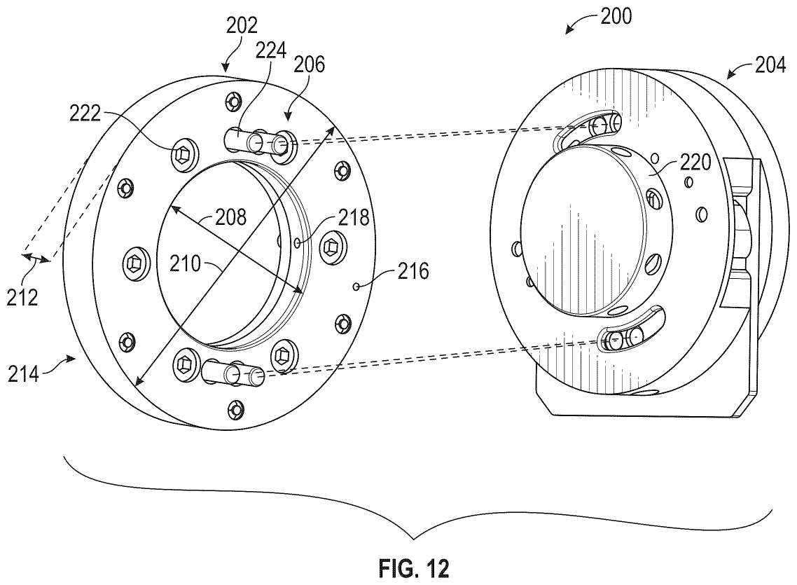

Another embodiment of a coupling mechanism 200 is shown beginning at FIG. 12. This embodiment, may function generally similarly to the coupling mechanism of FIGS. 1-11 where an engaging lock 230 actuates catches 250 that protrude out through a cylindrical sidewall 247 of coupling plug 220 to engage a groove 218 in a body portion 206 of a proximal portion 202. However, particular features relating to controlling the movement of the engaging lock 230 when the mechanism 200 is in the fixture 226 and out of the fixture 226 may differ.

As shown in FIG. 12, the coupling mechanism 200 may include a proximal portion 202 and a tool portion 204. The proximal portion 202 may be affixed to the wrist 58 of the robot 50 or tool arm, for example. The tool portion 204 may be arranged on an end effector 60 and may be adapted for selective engagement by the proximal portion 202.

With continued reference to FIG. 12, the proximal portion 202 may be configured to selectively engage the tool portion 204 of the coupling mechanism 200. The proximal portion may include a body portion 206 adapted for attachment to the robot 50 or tool arm. The body portion 206 may include a plate or other shape adapted for placement against and attachment to the wrist 58 of the robot 50 or tool arm. In one or more embodiments, the body portion 206 may include an annularly shaped plate with an outer diameter 210, an inner diameter 208, and a thickness 212. The outer diameter 210 may be selected to be the same, slightly smaller, and/or slightly larger than the wrist 58 and the inner diameter 208 may be selected to receive a coupling plug 220 of the tool portion 204. The thickness may be selected to receive the coupling plug 220 of the tool portion 204 and to allow for engagement with the coupling plug 220 on an inner surface thereof. The body portion may include a back face 214 adapted for securing against the wrist of the robot or tool arm and a front face 216 adapted for engaging the tool portion 204 of the coupling mechanism 200. The thickness 212 of the body portion 206 may establish an outside wall and an inside wall. The outside wall may be arranged along the outside diameter and may extend from the back face 214 to the front face 216 forming a substantially cylindrical outer surface. Similarly, the inside wall may be arranged along the inside diameter and may extend from the back face 214 to the front face 216. The inside wall may include a groove 218 extending around the length of the inside wall. The groove 218 may be adapted to receive a catch or ball 250 from the coupling plug 220 of the tool portion 204 to cause the proximal portion 202 and the tool portion 204 to lockingly engage.

In one or more embodiments, the body portion 206 may include a plurality of bores 222 extending through the body portion from the front face to the back face and adapted to receive fasteners to secure the body portion to the wrist of the robot or tool arm, for example. The body portion 206 may also include a plurality of protruding engagement features 224 extending from the front face 216 and adapted to engage with the tool portion 204 and trigger a locking mechanism. In one or more embodiments, the protruding engagement features 224 may include a plurality of dowels arranged along a circle having a diameter between the inner and outer diameters of the body portion 206. In one or more embodiments, the front face 216 may be a substantially flat face and the dowels may extend substantially perpendicular to the front face 216. The dowels may be spaced along the circle so as to engage openings in the tool portion 204.

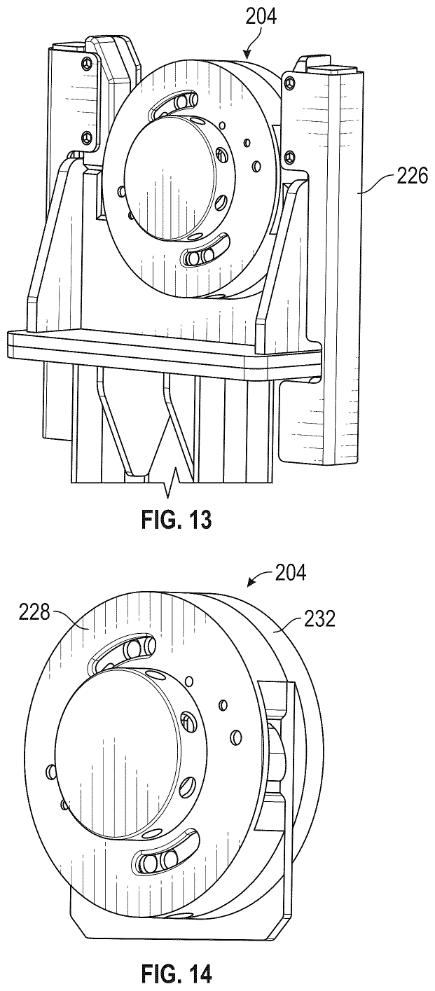

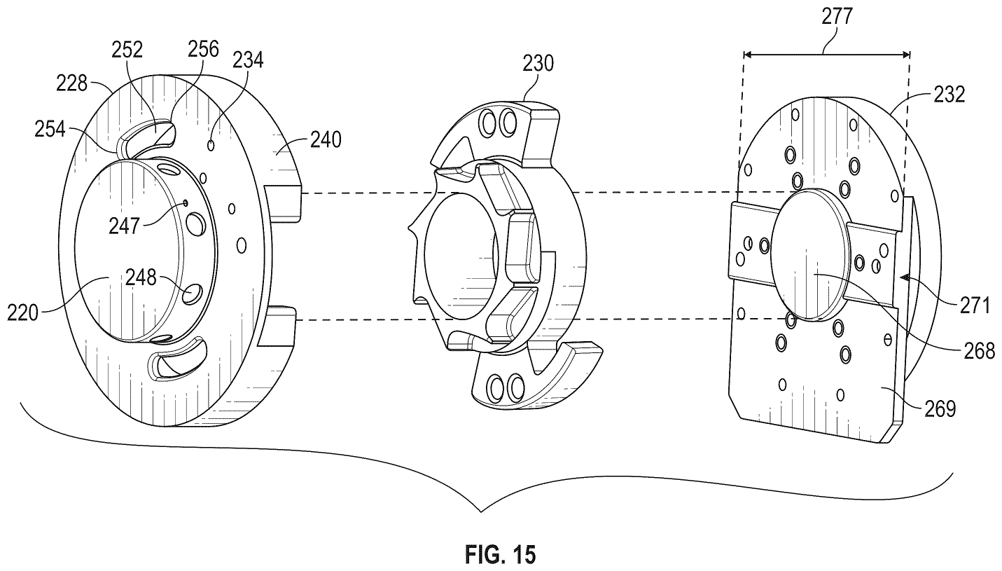

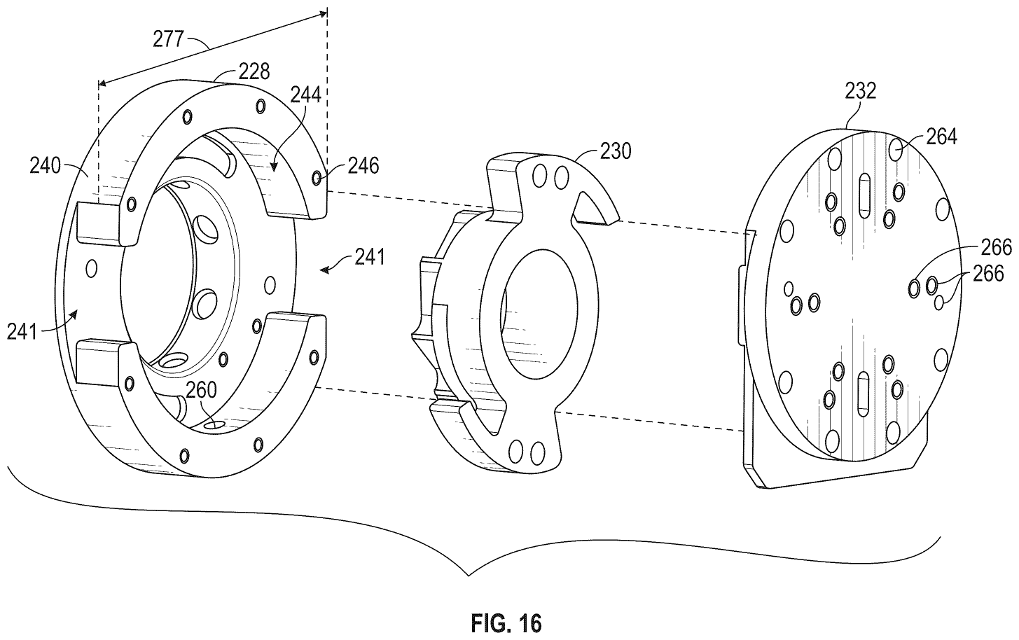

The tool portion 204 is shown in FIG. 13 arranged in a fixture 226. While an end effector is not shown, the tool portion 204 may have an end effector 60 secured to a back side thereof similar to tool portion 104. The tool portion 104 may be configured for resting in a fixture 226 as shown and for being resistant to rotation in the fixture 226. The tool portion 204 may be adapted for engagement by a robot or other tool arm or controlling device in the fixture 226 and lifting from the fixture by the robot, tool arm, or controlling device. The tool portion 204 may also be adapted to couple with the proximal portion 202 in secure fashion to withstand the pushing and pulling forces generated from operations of the robot, tool arm, or controlling device and, in some cases, the end effector handling tubulars. FIG. 14 shows a perspective view of the tool portion 204 and FIGS. 15 and 16 show perspective exploded views of the tool portion 204. As shown, the tool portion 204 may include an interfacing housing 228, an engaging lock 230, an end effector interface 232, and one or more relative rotation lock systems may be provided.

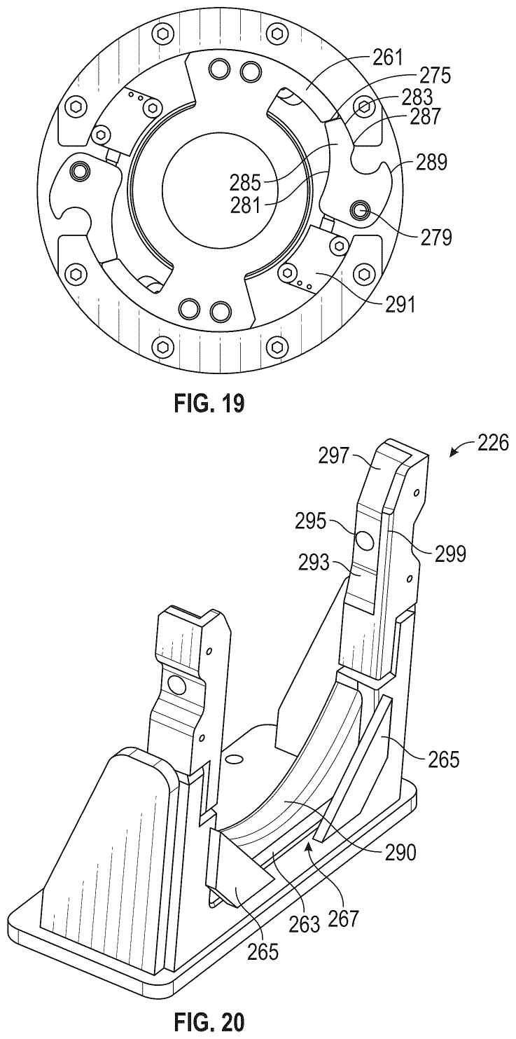

The interfacing housing 228 is shown in FIGS. 14-16. The interfacing housing 228 may be adapted to engage with the proximal portion 202 of the coupling mechanism 200 and may function together with the end effector interface 232 to engage the fixture 226. As shown, the interfacing housing 228 may include a front engagement plate 234. Unlike the interfacing housing 128, the interfacing housing 228 might not include a back engagement plate. The front engagement plate 234 may be annularly shaped and may extend radially outward from the coupling plug 220 to an outer peripheral edge. A peripheral wall 240 may be arranged along the outer peripheral edge. Together, the front engagement plate 234 and the peripheral wall 240 may define an internal cavity 244. As shown, the peripheral wall 240 may be relatively thick and may include a plurality of bores 246 each for receiving a fastener to connect the interfacing housing 228 to the end effector interface 232. In addition, the peripheral wall 240 may include access gaps 241 on the sides of the interfacing housing 228. The access gaps 241 may provide openings in the tool portion 204 that allow lock control flaps 243 (see FIGS. 18 and 19) to be engaged by the fixture 226 when the tool portion 204 is placed therein. That is, the access gaps 241 may allow lock control flaps 243 to extend beyond the perimeter of the peripheral wall 240 unless the tool portion 204 is placed in the fixture 226 where the fixture 226 may force the flaps 243 within the tool portion 204.

The interfacing housing 228 may also include a hub or plug 220 extending longitudinally from an inner radial edge of the front engagement plate 234. The hub or plug 220 may be sized and shaped to engage the body portion 206 of the proximal portion 202 of the coupling mechanism 200. That is, the hub or plug 220 may have a diameter selected to be slightly smaller than the inner diameter of the annularly shaped body portion 206 of the proximal portion 202, for example. The hub or plug 220 may also extend from the front engagement plate 234 by a distance similar to the thickness or slightly less than the thickness 212 of the body portion 206 of the proximal portion 202. The hub or plug 220 may have a cylindrical sidewall 247 including a plurality of openings 248 spaced along the periphery of the hub or plug 220 and extending through the sidewall 247. The openings 248 may be sized and shaped to allow actuated catches 250 to extend partially therethrough so as to engage the groove 218 on the inside wall of the body portion 206 of the proximal portion 202 of the coupling mechanism 200. That is, for example, the openings 248 may have a diameter slightly smaller than an engagement ball such that the ball may extend partially through the opening 248 and seat in the groove 218 of the proximal portion 202, but the opening 248 may prevent full exit of the catches or balls 250.

As shown, the interfacing housing 228 may include a plurality of circumferentially extending slots 252 extending through the front engagement plate 234. The slots 252 may be adapted to receive the dowels 224 from the proximal portion 202 and, as such, may be arranged on a diameter that is the same or similar to the diameter of the circle on which the dowels 224 of the proximal portion 202 are arranged. The diameter of the circle may be, for example, smaller than the diameter of the peripheral wall 240. The slots 252 may be kidney shaped, for example, so as to allow for rotation of the dowels 224 relative to the front engagement plate 234 after the dowels 224 are inserted into the slots 252. The dowels may be used to actuate the engaging lock 230 by insertion through the slots 252 and rotating relative to the front engagement plate 234. Referring to FIG. 15, in one or more embodiments, the kidney shaped slots may have an initial engagement end 254 and a locking end 256. That is, the dowels 224 from the proximal portion 202 may be inserted into the slots 252 at an initial engagement end 254 and then the dowels 224 may be rotated clockwise to a locking end 256 of the slots 252.

As best shown in FIG. 16, the interfacing housing 228 may include one or more openings 260 extending into and/or through the peripheral wall 240. The openings 260 may be adapted to allow fixture dowels to pass therethrough to rotationally secure the tool portion 204 to the fixture 226. In one or more embodiments, the openings 260 may be arranged through a bottom portion of the peripheral wall 240. In other embodiments, other positions may be used.

The end effector interface 232 may be arranged on an end of the tool portion 204 opposite the interfacing housing 228 and may provide a backing and attachment surface for the housing 228. The end effector interface 232 may close off the internal cavity 244 creating an internal operating space for the engaging lock 230 and the lock control flaps 243. The end effector interface 232 may include a relatively thick and substantially plate-like element having a circumferential bore circle near an outer peripheral edge. The bore circle may have a diameter that is the same or similar to the diameter of the circle on which the openings 246 along the peripheral wall 240 are arranged. A plurality of bores 264 may be spaced along the bore circle to align with the openings 246 on the peripheral wall 240. The relatively thick end effector interface secured to the relatively thick peripheral wall 240 may provide for a substantial component for securing the end effector. The back of the end effector interface 232 (e.g. the side facing the end effector and away from the robot or tool arm) may include a plurality of bores 266 for securing an end effector 60. The bores 266 may be threaded bores for bolting an end effector 60 thereto, for example.

The end effector interface 232 may also include a raised surface 268 on a front side thereof. The raised surface 268 may be circular and adapted to nest within an inner bore of the engaging lock 230 and perform a centering function for the engaging lock 230. A substantially rectangular raised surface may also be provided for securing the lock control flaps 243. The end effector interface may also include guide notches 271 on lateral sides of a front face. The guide notches 271 may define a width 277 across the front face of the end effector interface that is adapted to fit into the fixture 226. The peripheral wall 240 may have a same or similar width 277 along the guide notches 271 so as to similarly accommodate the fixture 226. The end effector interface 232 may also include a downwardly extending rotational guide 269. The guide 269 may have a width substantially the same as the width defined by the guide notches 271 and may be adapted to slip into the fixture 226 below the tool portion 204 and maintain the tool portion in vertical alignment as it exits the fixture unless/until the engaging lock 230 is held in position by the lock control flaps 243.

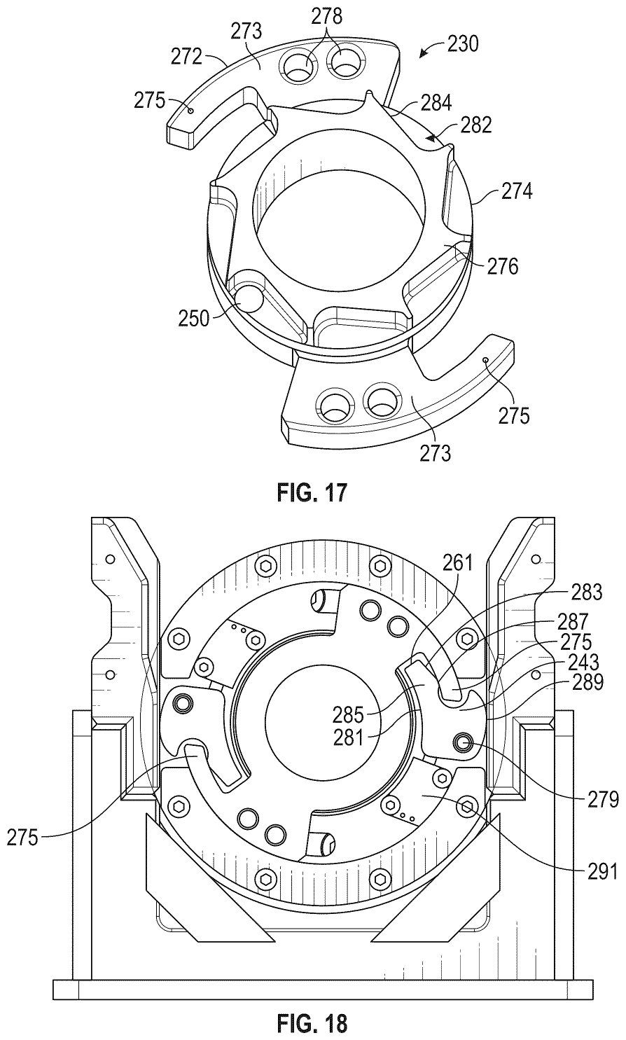

The engaging lock 230 is also shown in FIGS. 15 and 16 and an isolated perspective view is shown in FIG. 17. As shown, the lock 230 is sized and adapted to fit within the cavity 244 of the interfacing housing 228. The engaging lock 230 may be configured for rotation within the cavity 244 to cause the tool portion 204 of the coupling mechanism 200 to lockingly engage the proximal portion 202. In particular, the engaging lock 230 may rotate to drive locking balls 250 outward through the openings 248 in the cylindrical sidewall of the hub 220 of the interfacing housing 228. The balls 250 may engage the groove 218 on the inside wall of the body 206 of the proximal portion 202 of the coupling mechanism 200 thereby preventing relative longitudinal motion of the two parts. As shown in FIGS. 15-17, the engaging lock 230 may include a rotational guide 272, an offsetting platform 274, and a lock actuator 276.

The rotational guide 272 may be a substantially plate-like element or a pair of plate like elements defining a circular peripheral edge sized to fit within and rotate within the peripheral wall 240 defining the cavity 244. The rotational guide 272 may include a plurality of bores 278 extending therethrough. The bores 278 may be on a bore circle matching that of the circumferentially extending slots 252 on the front plate 234 of the interfacing housing 228. As shown, the bores 278 may include a pair of bores 278 arranged on respective ear portions of the guide 272. A first set of bores 278 may be arranged on one side of the guide 272 and another set of bores 278 on an opposite side of the guide 272. This may be in contrast to the fuller circular guide 172 and the more uniformly arranged bores 178. However, either paired up or more uniformly arranged bores may be used. In this case, the ear-type guide 272 and paired up bores 278 may provide space for operation of the lock control flaps 243. That is, as shown best in FIG. 17, the rotational guide 272 may include upper and lower ear portions 273. The ear portions may have a radiused outer edge configured for engaging an inner surface of the peripheral wall and may have radially extending sides defining ear portions having a shape akin to an outer portion of a piece of pie. The ear portions may also include trailing tails 275 adapted to be engaged the lock control flaps 243 when the tool portion 204 is out of the fixture 226. The trailing tails 275 may have a peripheral outer surface that is a circumferential continuation of the outer surface of the ear portions 273 and an inner surface defining a tail width narrower than the ear width and extending about the center of the guide.

The offsetting platform 274 may be a circular raised surface extending longitudinally forward (e.g., toward the robot or tool arm) from the rotational guide 272. The offsetting platform 274 may help to position the lock actuator 276 within the hub or plug 220 of the interfacing housing 228.

The lock actuator 276 may be arranged on the offsetting platform 274. The lock actuator 276 may be configured for selectively driving balls or other locking mechanisms 250 through the openings 248 of the hub or plug 220 on the interfacing housing 228 such that the balls or other locking mechanisms 250 engage the groove 218 on the proximal portion 202 of the coupling mechanism 200. As shown in FIGS. 15-17, the lock actuator 276 may be generally star shaped when viewed from the front. That is, for example, the lock actuator 276 may have a thickness and outer diameter similar to the thickness of the hub or plug 220 on the interfacing housing such that the lock actuator 276 fits within the hub or plug 220. The peripheral surface of the lock actuator 276 may be defined by a plurality of sockets 282 having sloping ramps 284 extending therefrom. For example as shown in FIG. 17, a curved ball socket 282 may be formed on a counterclockwise side of each star blade and a ramp 284 may extend further counterclockwise from the ball socket 282 generally linearly to the outer surface of the lock actuator 276 at a location substantially flush with the outer diameter of the offsetting platform 274.

In operation, the engaging lock 230 may function to secure the proximal portion 202 and the tool portion 204 to one another. For example, a ball 250 may rest in the ball socket 282 and be held in that position by partial engagement with the openings 248 in the hub 220 of the interfacing housing 228. In this position the engaging lock 276 may be unlocked (e.g., the balls are recessed within the openings 248 in the hub 220). The engaging lock 230 may rotate clockwise within the interfacing housing 228 relative to the housing 228 and relative to the ball 250, the ball 250 being held in place by the openings 248 in the hub 220. As the engaging lock 230 rotates clockwise, the ramps 284 on the outer surface of the lock actuator thereof may drive the ball 250 radially outward and partially through the openings 248 in the sidewall 246 of the hub 220. In this position, the lock actuator 230 may be locked (e.g., the balls 250 are driven radially outward to engage the groove 218 in the proximal portion 202 of the coupling mechanism 200).

Without more, the engaging lock 230 may rotate relatively freely at least between an unlocked position and a locked position. For purposes of restricting free motion of the lock actuator 230 and controlling alignment of the lock actuator 230 with other components, one or more relative rotation lock systems may be provided. While the coupling mechanism 100 included first and second relative rotation lock systems and a series of bias pins 192, the present coupling mechanism may, more simply, include a single relative rotation lock system. That is, as shown in FIGS. 18 and 19, a pair of lock control flaps 243 may be provided to control the rotation of the lock 230. As shown in FIG. 18, the coupling mechanism 200 may be arranged in the fixture 226 and the lock control flaps 243 may be forced inwardly by the fixture in a release position. In FIG. 19, the coupling mechanism 200 may be removed from the fixture and the lock control flaps 243 may be biased outwardly into a holding position. In this position, noses 261 of the lock control flaps may abut the tails 275 of the lock 230 and hold the lock 230 in position against rotation.

With continued reference to FIGS. 18 and 19, the relative rotation lock system may be described in more detail. As shown, the lock control flaps 243 may include generally J-shaped elements having a pivot pin 279 arranged near a toe of the J-shape at or near the bottom of the up-turned hook portion of the shape. The vertical leg of the J-shape may include an inner surface 281 (e.g., inner relative to the center of the coupling mech) that is curved to follow, but remain spaced apart from, the outer surface of the offsetting platform 274 in the release position shown in FIG. 18. The outer surface 283 (e.g., outer relative to the center of the coupling mech) of the vertical leg 285 may also be curved near a top portion thereof and be adapted to nest against the inside surface of the peripheral wall 240 in the holding position shown in FIG. 19. Moreover, the curve may extend downward along the vertical leg 285 and curve further inward (e.g., relative to the J shape) near the bottom portion of the leg forming a bite surface or point 287. As shown in FIG. 18, this bite surface or point 287 may engage an inside surface of the tail 275 of the lock 230 when the mechanism 200 is in the fixture 226. The outside surface 289 of the hooked portion of the J-shape may include a curved cam surface adapted to be engaged by the fixture 226 to cause the lock control flaps to rotate about the pivot pin 279 as the tool portion 204 is placed into the fixture 226. As shown, each of the lock control flaps 243 may include a biasing mechanism 291 arranged under a heel portion of the J-shape. The biasing mechanism 291 may include a biasing pin that is urged against the heel of the J-shape with a biasing device such as a spring or other resilient member or device. The biasing force from the biasing device may cause the J-shape to have a natural or biased position toward the holding position shown in FIG. 19. This biasing force may be overcome when the tool portion 204 is placed in the fixture 226 and the cam surfaces 289 ride along the guide surfaces of the fixture 226 causing the lock control flaps 243 to rotate about the pivot pin 279 against the biasing force to the position shown in FIG. 18.

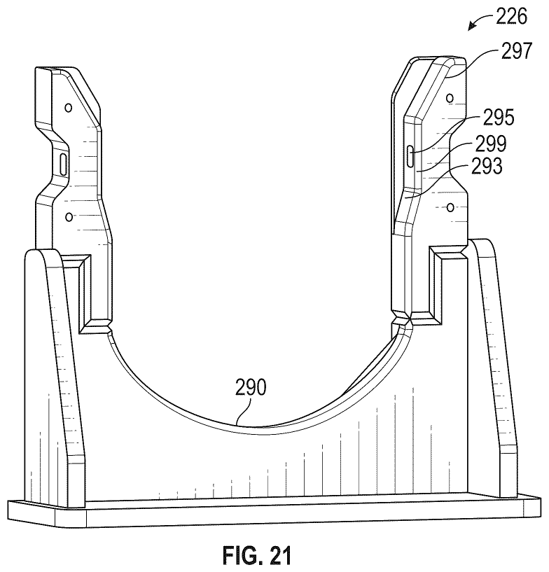

Turning now to FIGS. 20 and 21, the fixture 226 may include a saddle 290 for receiving the tool portion 204 of the coupling mechanism 200. The saddle 290 may be sized and curved to provide for seating of the tool portion 204 of the coupling mechanism 200 by engagement with an outside surface of the peripheral wall 240. For example, a radiused or otherwise curved saddle 290 may be provided as shown. The sides of the saddle may extend upward substantially vertically to diverging ramps 293 that extend outward and upward to vertically extending guide walls 295, which extend further upward to centering ramps 297 that also diverge and extend outward and upward. Out of plane, but adjacent to the saddle and the series of ramps and guide walls, a guide rib 299 may be provided. Still further, adjacent the saddle and in line with the guide rib, a plate slot 267 may be provided. The slot 267 may be created by a pair of diagonally extending brace plates 265 and a groove or slot 263 in a base plate of the fixture 226. While a curved saddle 290 has been described, alternatively, a rectangular or square saddle 290 may be provided. In still other embodiments, vertically extending bars or rods spaced from one another to allow the tool portion to slip between them may be provided and a separate chair, table, or stand may be provided between them. Still other saddle shapes may be provided.

In operation and use, a robot or user using a tool arm or other rotatable device may engage or release an end effector or other tool using the described coupling mechanisms 100/200. That is, with reference back to FIGS. 1 and 13, for example, the robot or user may place the end effector it is currently coupled to in the empty fixture and release the end effector. The robot or user may then engage the end effector in another fixture, couple to the end effector, and remove the end effector from the fixture such that a different end effector may be used to manipulate pipe or tubulars or perform other operations. A more detailed discussion below with respect to each type of coupling mechanism 100/200 may help to describe the decoupling and coupling process.

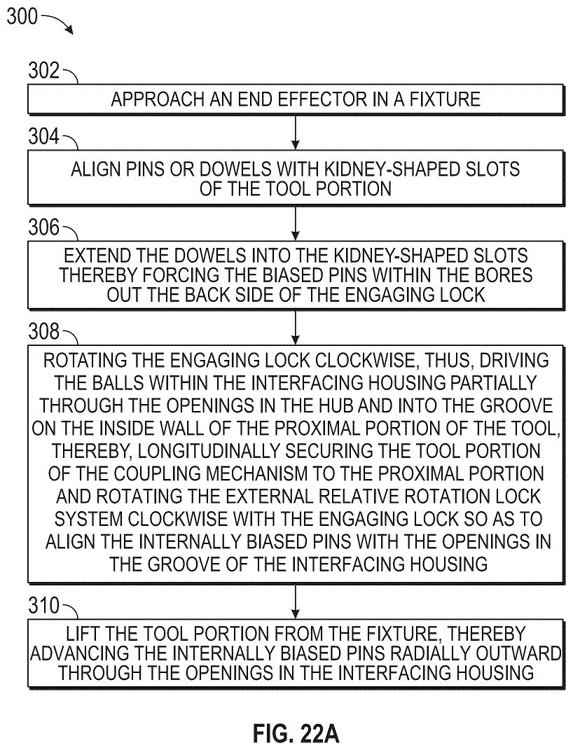

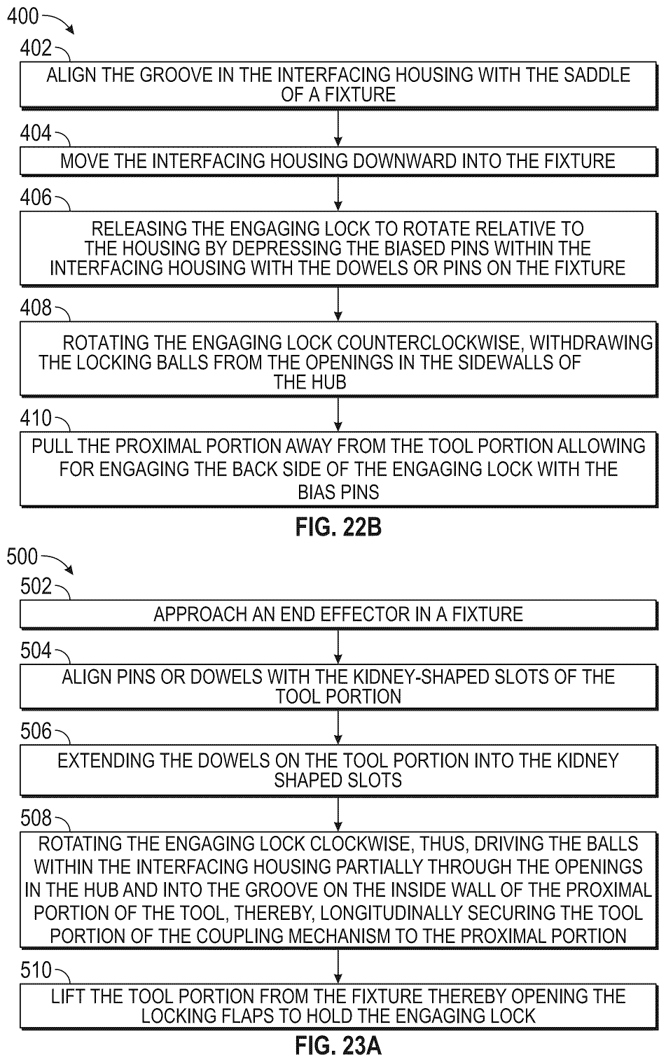

A robot or user may couple to an end effector or other tool using a method of coupling 300 as shown in FIG. 22A. For example, a robot or user with a tool arm or other rotatable item may approach an end effector in a fixture (302). The robot or tool arm may include a proximal portion 102 of a coupling mechanism 100 secured to a wrist thereof and the end effector may be secured to or include the tool portion 104 of the coupling mechanism 100. As the robot or tool arm approaches, the pins or dowels extending from the proximal portion 102 of the coupling mechanism may be aligned with the kidney-shaped slots of the tool portion 104. (304) In particular, the dowels may be aligned with a counterclockwise end of the kidney-shaped slots. In the fixture position, the engaging lock 130 of the tool portion 104 may be positioned in its most counterclockwise position and the biased pins between the end effector interface and the engaging lock may be engaged with a back side of the bores in the engaging lock. The robot or tool arm may engage the tool portion by extending the dowels into the kidney-shaped slots thereby forcing the biased pins within the bores out the back side of the engaging lock. (306) This may free up the engaging lock 130 within the tool portion for rotation. The tool portion may, however, remain resistant to rotation relative to the fixture due to the dowels extending into the tool portion from the fixture. The robot or tool arm may rotate the engaging lock clockwise. (308) This process may drive the balls within the interfacing housing partially through the openings in the hub and into the groove on the inside wall of the proximal portion of the tool thereby longitudinally securing the tool portion of the coupling mechanism to the proximal portion. Moreover, upon rotating the engaging lock, the external relative rotation lock system may be rotated clockwise so as to align the internally biased pins with the openings in the groove of the interfacing housing. The robot or tool arm may then lift the tool portion from the fixture (310) and the internally biased pins may advance radially outward through the openings in the interfacing housing and preventing relative rotation of the engaging lock and the remaining portions of the tool portion of the coupling mechanism. It is to be appreciated that the biased pins may enter the openings simultaneously with the fixture pins exiting the openings. The wall thickness of the grooved portion of the interfacing housing together with its sloping nature as you move away from the centerline of the fixture may provide a sufficiently long bore to ensure that the internal biased pins enter the openings before the tool portion is fully free from the fixture. Upon lifting the tool portion and its attached end effector from the fixture, the tool portion may be both longitudinally and rotationally secured to the proximal portion.

To release or decouple from an end effector, the robot or user may perform a method of decoupling 400 as shown in FIG. 22B. For example, the robot or user may align the groove in the interfacing housing with the saddle of a fixture (402) and move the interfacing housing downward into the fixture (404). The front and back engagement plate of the interfacing housing may sandwich the saddle plate of the fixture. Also, the dowels or pins on the fixture may depress the biased pins within the interfacing housing on the bottom of the engaging lock, thus, releasing the engaging lock to rotate relative to the housing. (406) The robot or user using a tool arm may rotate the engaging lock counterclockwise. (408) The force from the sloping surfaces on the lock actuator may subside due this rotation, leaving the balls to be free to withdraw from the openings in the sidewalls of the hub thereby longitudinally freeing the tool portion from the proximal portion of the coupling mechanism. The counterclockwise rotation may also bring the bores through the engaging lock into alignment with the biased pins on a back side thereof. The robot or tool arm may, thus, pull the proximal portion away from the tool portion and the bias pins may engage the back side of the engaging lock thereby securing it in position relative to the interfacing housing. (410)

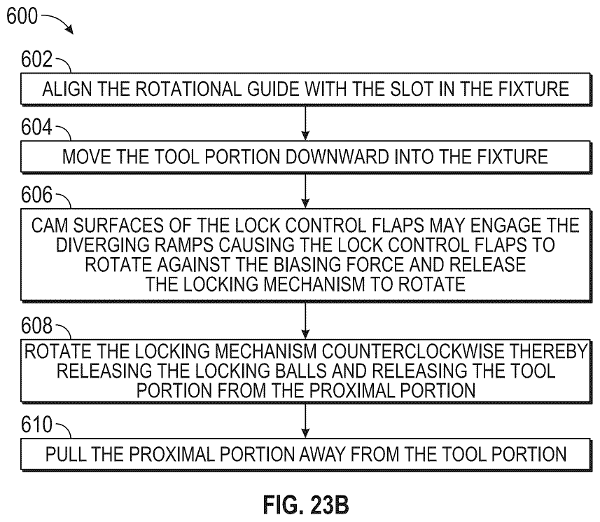

While a method of coupling 300 and decoupling 400 has been described with respect to the coupling mechanism 100, methods of coupling 500 and decoupling 600 may also be provided with respect to coupling mechanism 200 as shown in FIGS. 23A and 23B. For example, a robot or user may couple to an end effector or other tool using a method of coupling 500. A robot or user with a tool arm or other rotatable item may approach an end effector in a fixture (502). The robot or tool arm may include a proximal portion 202 of a coupling mechanism 200 secured to a wrist thereof and the end effector may be secured to or include the tool portion 204 of the coupling mechanism 200. As the robot or tool arm approaches, the pins or dowels extending from the proximal portion 202 of the coupling mechanism may be aligned with the kidney-shaped slots of the tool portion 204. (504) In particular, the dowels may be aligned with a counterclockwise end of the kidney-shaped slots. With the tool portion 204 in the fixture position, the engaging lock 230 of the tool portion 104 may be positioned in its most counterclockwise position when viewed from the front (most clockwise position when viewed from the back as in FIG. 18). Moreover, as shown, the lock control flaps may be pressed inward by the fixture against the biasing force, but the biting surface or point may be engaged with the inside surface of the tails of the locking mechanism 230. This may function to hold the locking mechanism 230 in position and ready for engagement by the proximal portion 202 when the tool portion 204 is in the fixture. Holding the locking mechanism 230 in this position when the tool portion 204 is in the fixture, may help to ensure that the locking balls 250 remain recessed in the openings 248 unless until the dowels are inserted and the lock 230 is actively rotated against the friction caused by the lock control flaps 243. That is, the robot or user may engage the tool portion 204 by extending the dowels on the tool portion into the kidney-shaped slots (506) rotating the engaging lock clockwise. (508) This may drive the balls within the interfacing housing partially through the openings in the hub and into the groove on the inside wall of the proximal portion of the tool thereby longitudinally securing the tool portion of the coupling mechanism to the proximal portion. It is to be appreciate that rotation of the tool portion 204 may be prevented and/or resisted by the downwardly extending rotational guide 269. With the proximal portion 202 secured to the tool portion 204, the robot or user may then lift the tool portion 204 from the fixture (510). It is to be appreciated that the downwardly extending rotational guide 269 may provide for prolonged rotational resistance of the tool portion 204 as the tool portion is lifted from the fixture 226. This may allow rotation of the tool portion 204 to be resisted long enough for the lock control flaps 243 to rise up along the lower set of ramps and open up to the position of FIG. 19 and hold the lock 230 in position against rotation through engagement of the flap noses 261 with the tails 275 of the lock 230. This may function to hold the locking balls 250 through the openings 248 and maintain a secured position of the tool portion 204.

To release or decouple from an end effector, the robot or user may perform a method of decoupling 600. For example, the robot or user may align the rotational guide 269 with the slot in the fixture (602) and move the tool portion 204 downward into the fixture (604). As the tool portion moves downward into the fixture, the guide ramps may help to center the tool portion in the fixture. As the tool portion moves further downward into the fixture, the cam surfaces of the lock control flaps may engage the diverging ramps causing the lock control flaps to rotated against the biasing force and release the locking mechanism 230 to rotate. (606) As such, once the tool portion is fully placed in the fixture, the robot or user may rotate the locking mechanism 230 counterclockwise (clockwise in FIG. 19) (608) to release the locking balls 150 and release the tool portion 204 from the proximal portion 202. The robot or user may then pull the proximal portion away from the tool portion leaving the tool portion behind in the fixture (610).

It is to be appreciated that the design features of the coupling mechanisms 100 and 200 allow the methods of coupling and decoupling to be actuated solely by movement of the robot components or a user's tool arm and, in particular, by twisting of the robot wrist or tool arm causing rotation of the engaging lock. As such, the coupling mechanisms 100 and 200 may be deemed a passive coupling mechanism because no outside actuation systems such as hydraulics, compressed air, or other force providing systems are relied on for actuation of the coupling mechanism. Nonetheless, a secure connection may be provided that is highly resistant to release and that provides for longitudinal rotational coupling to the robot or tool arm allowing for full manipulation and control of the end effector or other tool secured to the coupling mechanism.

In some embodiments, a pipe handling robot of the present disclosure may be arranged on a drilling rig, such as an on-shore or off-shore oil drilling rig. For example, a first robot may be arranged on or near the drill floor or such a rig, and a second robot may be arranged on or near a racking board of the rig. The robot(s) may operate to manipulate drill pipe during stand building, trip in, trip out, and/or other operations, as described in U.S. application Ser. No. 16/431,533, entitled Devices, Systems, and Methods for Robotic Pipe Handling, filed Jun. 4, 2019, the content of which is incorporated by reference herein in its entirety and is also presented immediately below.

The present disclosure, in one or more embodiments, relates to systems and methods for automated drill pipe handling operations. In particular, a pipe handling system of the present disclosure may include a lifting system and one or more drill handling robots and may be configured for performing trip in, trip out, stand building, and/or other drill pipe or drill collar handling operations. The lifting system may include a primary drill line of a drilling rig, which may be reeved between a crown block and a traveling block and a top drive or other pipe string handling device may be hung from the travelling block. The traveling block may be raised and lowered using a draw works to raise and lower the top drive and the pipe stand. Each pipe handling robot may be configured to engage with and manipulate an end of the pipe stand. In some embodiments, a first pipe handling robot may be a drill floor robot arranged on or near a drill floor of the drilling rig. A second robot may be a racking board robot arranged on or near a racking board of the drilling rig. The robots and the lifting system may operate together to move stands of drill pipe between a setback area of the drill floor and well center for trip in and trip out operations. In some embodiments, the drill floor robot may be configured to engage with and manipulate a lower end of the pipe stand while the racking board robot may be configured to engage with and manipulate an upper end of the pipe stand. In some embodiments, each robot may operate to manipulate an end of the pipe stand without the need for a derrickhand or other human operator to physically handle the pipes. In this way, systems and methods of the present disclosure may provide for safer, more precise, and more efficient pipe handling operations as compared with conventional systems and methods.

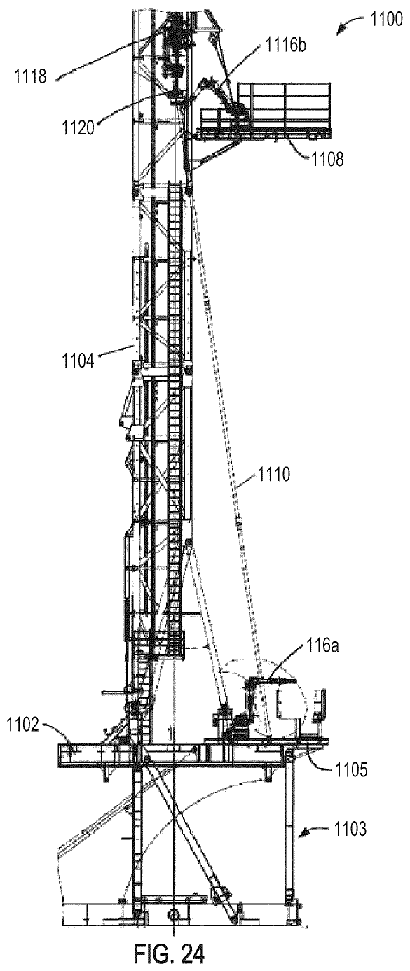

Turning now to FIG. 24, a drilling rig 1100 of the present disclosure is shown. The drilling rig 1100 may be configured for onshore oil drilling in some embodiments. However, in other embodiments, other drilling rigs of the present disclosure may be configured for other drilling operations, including offshore drilling. The drilling rig 1100 may be configured to be a mobile or stationary rig. The drilling rig 1100 may generally have a drill floor 1102, a mast 1104, and a pipe handling system.

The drill floor 1102 may include a platform positioned above or over a well and supported by a substructure 1103. The drill floor 1102 may be configured to provide a working space for drilling operations and/or a storage space for equipment and drill pipe. The drill floor 1102 may have an opening arranged at or near well center for accessing the well during drilling operations. The drill floor 1102 may additionally include a setback area 1105 configured for receiving and/or storing lengths of drill pipe. For example, lengths of drill pipe may be stored as single stands, or may be combined into double stands, triple stands, quadruple stands, or other sized stands 1110, and positioned on end in the setback area 1105.

The mast 1104 may extend from the drill floor with a height suitable for accommodating and/or building single, double, triple, quadruple, or other sized drill pipe stands. For example, the mast 1104 may have a height of up to 50 feet, 100 feet 150 feet, 200 feet, or more. In other embodiments, the mast 1104 may have any other suitable height or height range. In some embodiments, a racking board 1108 may extend from the mast 1104. The racking board 1108 may be configured for managing the top portion of pipe stands to maintain or store stands of pipe in a generally organized manner. In some embodiments, pipe stands 1110 may be stored with a first or lower end arranged on the drill floor 1102 in the setback area 1105, and a second end or upper end extending in or through a racking board 1108. The racking board 1108 may extend laterally from the mast 1104 at height of between approximately 30 feet and approximately 200 feet from a ground or pad surface, or between approximately 40 feet and approximately 150 feet, or between approximately 50 feet and approximately 100 feet. In other embodiments, the racking 1108 board may extend from the mast 1104 at any other suitable height.

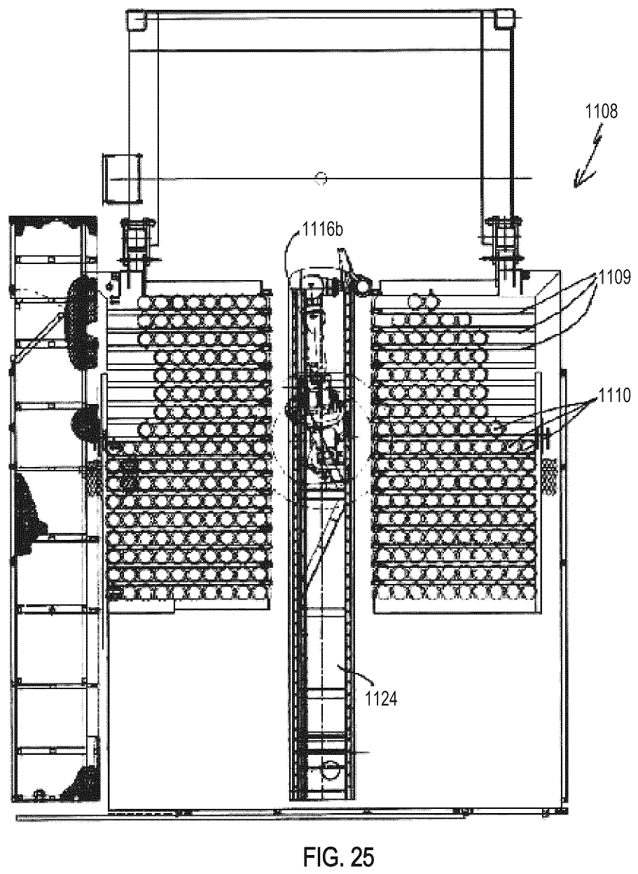

FIG. 25 shows an overhead view of a racking board 1108, according to some embodiments. The racking board 1108 may include a plurality of fingers 1109, which may be arranged in a parallel configuration, configured to receive stands 1110 of pipe therebetween so as to maintain the pipe stands in an upright, on-end configuration. The fingers 1109 of the racking board 1108 may operate to maintain stands of pipe in organized rows or columns. In particular, the racking board 1108 may be configured such that a plurality of pipe stands 1110 may be arranged in a row or column between each pair of racking board fingers 1109. In some embodiments, pipe stands 1110 may be added to the racking board 1108 as they are built. The racking board 1108 may store the pipe stands 1110 until they are added to a drill string during a trip in operation. Moreover, during a trip out operation, pipe stands 1110 may be removed from the drill string and added to the racking board 1108 until they are either tripped back into the well or disassembled. The racking board 1108 may additionally or alternatively be configured to store pipe stands 1110 during other operations as well.

With reference back to FIG. 24, the drilling rig may additionally include a pipe handling system. The pipe handling system may be configured for manipulating and moving lengths or stands of pipe, such as for trip in and trip out operations, stand building, and/or other operations. The pipe handling system may include a lifting system, a pipe coupling mechanism 1114, and one or more robots or robotic handlers 1116.

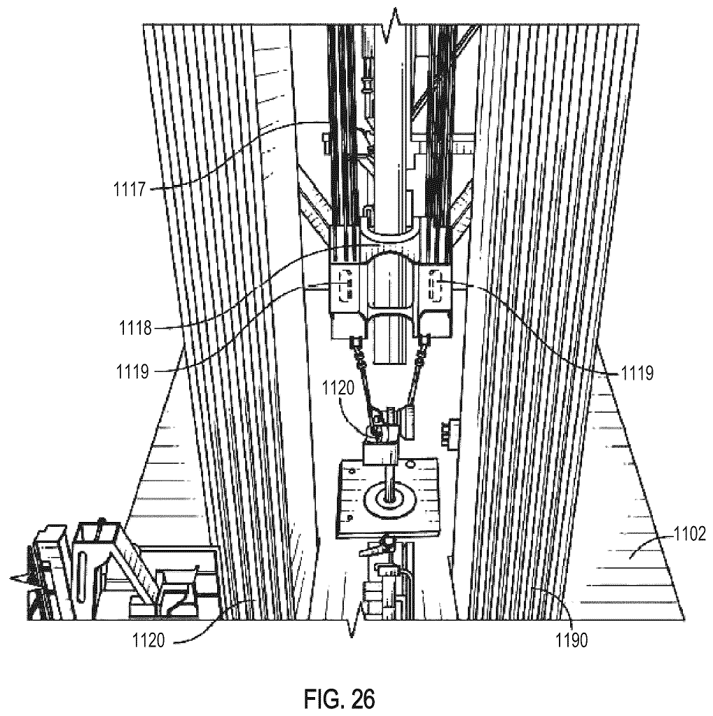

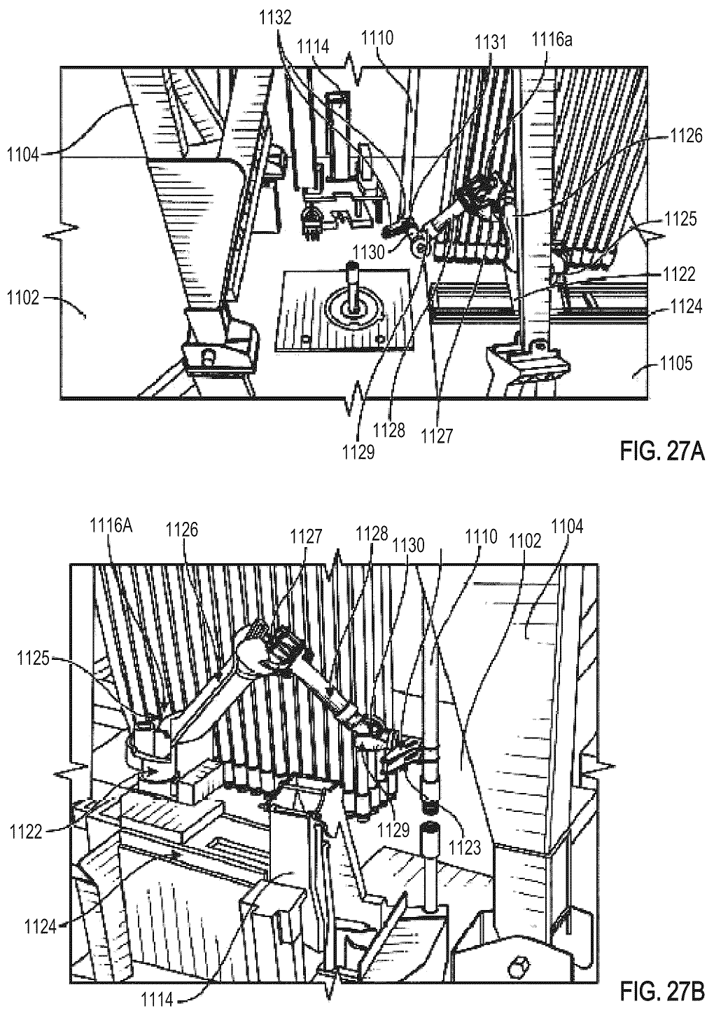

The lifting system may be configured for supporting the load of a pipe stand 1110 and/or drill string during a trip in, trip out, and/or other pipe handling operation. For example, the lifting system may be configured to support a pipe stand load as robots 1116 or operators maneuver the pipe stand 1110 between a racking board 1108 and a well center. The lifting system may include a drill line or cable extending from a draw works. The drill line may be reeved between a crown block, arranged at or ear a top of the mast 1104, and a traveling block 1118, arranged beneath the crown block and within the mast. In some embodiments, the drill line may be a main or primary line that may be otherwise configured for use during drilling operations using a top drive, for example. A pipe elevator 1120 configured for coupling to a drill pipe may extend from the traveling block 1118. In some embodiments, the pipe elevator 1120 may be incorporated into a top drive, which may be coupled to the traveling block 1118 via a hook dolly or the pipe elevator 1120 may be more directly coupled to the traveling block 1118 via a hook dolly. In either case, the traveling block 1118 may be configured to raise and lower the pipe elevator 1120, so as to raise and lower a length or stand of pipe 1110, between the drill floor 1102 and the crown block. FIG. 26 shows a close-up view of the traveling block 1118 arranged on the main drill line 1117, and the pipe elevator 1120 extending from the traveling block. As shown, the traveling block 1118 may include one or more sheaves 1119 through which the main drill line 1117 may be reeved.

The pipe handling system may include one or more mechanisms for coupling and/or decoupling lengths of drill pipe. In particular and with reference to FIG. 27, one or more iron roughnecks 1114 may be arranged on the drill floor 1102. For example, an iron roughneck 1114 may be arranged on the drill floor 1102 near well center, and may be configured to reach drill pipe stands 1110 above or on the drill floor. The iron roughneck may be configured to couple stands 1110 of drill pipe together to form the drill string, such as during a trip in operation, and/or may be configured to decouple stands of drill pipe from the drill string, such as during a trip out operation. The iron roughneck 1114 may additionally operate to couple lengths of drill pipe together to form a pipe stand 1110, and/or to decouple lengths of pipe to deconstruct a stand. The iron roughneck 1114 may generally have static and torque wrenches configured to screw together pipe lengths with threaded ends. In other embodiments, the pipe handling system may include additional or alternative pipe coupling devices or mechanisms.

Each robot 1116 (e.g., racking board robot and drill floor robot) may be configured to manipulate drill pipe lengths or stands 1110, drill collar, and/or other piping. The robots 1116 may each be programmable for carrying out particular sequences of operations. A handling system 1106 may have one, two, three, four, or any other suitable number of robots 1116. For example, a pipe handling system of the present disclosure may include a first robot 1116a arranged on or near the drill floor 1102, and a second robot 1116b arranged on or near the racking board 1108. In some embodiments, two robots 1116 may be generally aligned with one another. For example, the racking board robot 1116b may be centrally arranged on a racking board 1108, and the drill floor robot 1116a may be positioned in a setback area 1105 of the drill floor 1102 beneath and generally aligned with the racking board robot. In other embodiments, robots 1116 may be positioned differently, but may generally be arranged in corresponding configurations. In some embodiments, robots 1116 may be arranged in corresponding pairs, with an upper or racking board robot 1116b configured to handle an upper end of piping and a corresponding lower or drill floor robot 1116a configured to handle a lower end of piping.

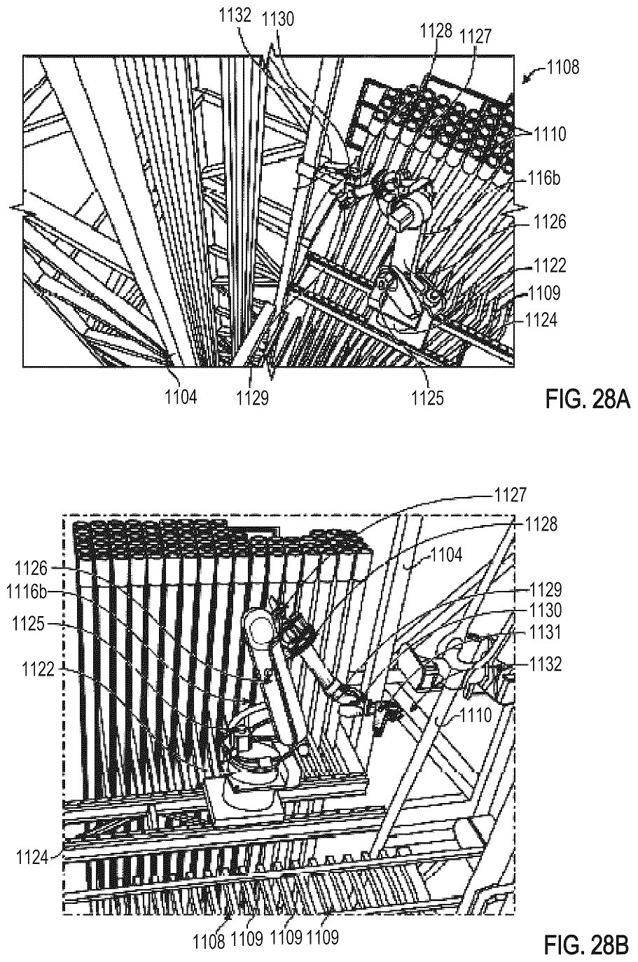

FIG. 27 shows an embodiment of a robot 1116a arranged on the drill floor 1102, according to one or more embodiments. The drill floor robot 1116a may be configured for handling a first end of pipe stands 1110, the first end being an end positioned closest the drill floor 1102 when the pipe stands are arranged within the racking board 1108. In some embodiments, the first end of the pipe stand 1110 may be referred to as a lower end. FIG. 28 shows an embodiment of a robot 1116b arranged on the racking board 1108, according to one or more embodiments. The racking board robot 1116b may be configured for handling a second end of pipe stands 1110, the second end being an end positioned closest the racking board 1108 when the pipe stands are arranged within the racking board. In some embodiments, the second end of the pipe stand 1110 may be referred to as an upper end. As shown in FIGS. 4 and 5, each of the robots 1116 may include a base portion 1122, which may be arranged on a track 1124. The robots 1116 may additionally each include a shoulder portion 1126, an articulated arm 1128, a wrist portion 1130, and an end effector 1132. Each robot 1116 may have a reach capacity of between approximately 4 feet and approximately 20 feet, or between approximately 6 feet and approximately 15 feet, or between approximately 8 feet and approximately 10 feet. In other embodiments, each robot 1116 may have any other suitable reach capacity. Moreover, each robot 1116 of the present disclosure may have a load capacity at full reach of between approximately 200 pounds and approximately 900 pounds, or between approximately 300 pounds and approximately 700 pounds, or between approximately 400 pounds and approximately 500 pounds. In other embodiments, each robot 1116 may have any other suitable load capacity at full reach.

The base portion 1122 of each robot 1116 may be configured to couple the robot to the drill floor 1102, racking board 1108, or another suitable location on the drilling rig 1100. In some embodiments, the base portion 1122 may additionally be configured to facilitate movement of the robot 1116 on the drill floor 1102, racking board 1108, or other surface of the drill rig 1100. For example, the base portion 1122 may be configured to engage with a track 1124 or rail, as shown in FIGS. 27 and 28. The base portion 1122 may have skids or rollers configured for sliding engagement with the track 1124. The track 1124 may provide a first axis of movement. In some embodiments, the track 1124 may provide a second axis of movement, such that the base portion 1122 may move in both an X-direction and a Y-direction. In some embodiments, the track 1124 may be positioned so as to be centrally arranged with respect to stored pipe stands 1110. For example, where pipe stands 1110 are stored on two sides of a racking board 1108 and/or setback area 1105, the track 1124 may be centrally aligned between the two sides, such that the robot may readily access pipe stands stored on both sides of the racking board and/or setback area. In particular, the track 1124 may be arranged between a driller's side and an off-driller's side of the setback area 1105, and may provide an axis of movement extending between the well center and an edge of the drill floor. The track 1124 may have a length of between approximately 1 foot and approximately 20 feet, or between approximately 2 feet and approximately 15 feet, or between approximately 3 feet and approximately 10 feet. In at least one embodiment, the track 1124 may have a length of approximately 13 feet. In some embodiments, the track 1124 of either or both robots 1116 may have a length equal to or slightly larger or slightly smaller than a length of the racking board 1108. In some embodiments, the robots 1116 may have tracks 1124 of equal length and configuration, while in other embodiments an upper robot 1116b may have a track with a different length and/or different configuration than that of a lower robot.

It is to be appreciated that in other embodiments, the base portion 1122 may have other movement means for moving the robot 1116 along a drill floor 1102, racking board 1108, or other surface. For example, the base portion 1122 may have wheels or treads or may be configured with a walking mechanism. In still other embodiments, other movement means are contemplated as well.

Each robot 1116 may have a shoulder portion 1126 extending from the base portion 1122. The shoulder portion may couple to the base portion via a joint 1125, which may be a swivel joint in some embodiments. The swivel joint 1125 may allow the shoulder portion 1126 to twist or rotate about a central axis with respect to the base portion 1122. In some embodiments, the shoulder portion 1126 may be configured to twist up to 360 degrees, up to 270 degrees, up to 180 degrees, up to 90 degrees, up to 45 degrees, or up to a different suitable degree of rotation. In other embodiments, the shoulder portion 1126 may couple to the base portion 1122 with a different joint, or the shoulder may couple to the base portion without a joint. The shoulder portion 1126 may extend generally upward from the base portion 1122, and in some embodiments, may extend upward at an angle, such that a longitudinal axis of the shoulder portion may be offset from a longitudinal axis of the base portion by approximately 10, 15, 20, 25, 30, 35, 40, 45 degrees, or any other suitable degree of offset. The shoulder portion 1126 may have a length of between approximately 12 inches and approximately 100 inches, or between approximately 18 inches and approximately 75 inches, or between approximately 24 inches and approximately 60 inches.

The articulated arm 1128 may extend from the shoulder portion 1126. In particular, where the shoulder portion 1126 couples at a first, or proximal, end to the base portion 1122, the articulated arm 1128 may extend from a second, or distal, end of the shoulder portion. A joint or elbow 1127, which may be a pitch joint, may be arranged between the articulated arm 1128 and the shoulder portion 1126. The pitch joint 1127 may allow the articulated arm 1128 to pivot with respect to the shoulder portion 1126 about an axis extending lateral to the shoulder portion and articulated arm. In some embodiments, the pitch joint 1127 may allow the articulated arm 1128 to pivot within a range of up to 360 degrees, up to 270 degrees, up to 180 degrees, up to 90 degrees, up to 45 degrees, or up to any other suitable degree of rotation. In other embodiments, the articulated arm 1128 may couple to the shoulder portion 1126 via a different joint or without a jointed connection. The articulated arm may have a length of between approximately 20 inches and approximately 100 inches, or between approximately 28 inches and approximately 75 inches, or between approximately 35 inches and approximately 50 inches.

The wrist portion 1130 may extend from the articulated arm 1128. For example, where the articulated arm 1128 couples at a first, or proximal, end to the shoulder portion 1126, the wrist 1130 may extend from a second, or distal, end of the articulated arm. A joint 1129 may be arranged between the wrist portion 1130 and the articulated arm 1128 and may provide for pivotable or rotational movement of the wrist with respect to the articulated arm about one or more axes. The joint 1129 may be or include a pitch joint allowing for pivotable movement about a first lateral axis extending lateral to the articulated arm 1128 and wrist 1130, a yaw joint allowing for pivotable movement about a second lateral axis perpendicular to the first lateral axis, and/or a roll joint allowing for pivotable or rotational movement about an axis extending longitudinally through the wrist portion. The wrist portion 1130 may have pivotable or rotational movement about each axis within a range of up to 360 degrees, up to 270 degrees, up to 180 degrees, up to 90 degrees, up to 45 degrees, or up to any other suitable degree of rotation. In other embodiments, the wrist portion 1130 may couple to the articulated arm 1128 via a different joint or without a jointed connection. The wrist 1130 may be configured to provide a mechanical interface or mounting point for coupling an end effector 1132 to the robot 1116. In some embodiments, a joint 1131, such as a pitch, yaw, and/or roll joint, may allow for pivotable movement of the end effector with respect to the wrist portion.

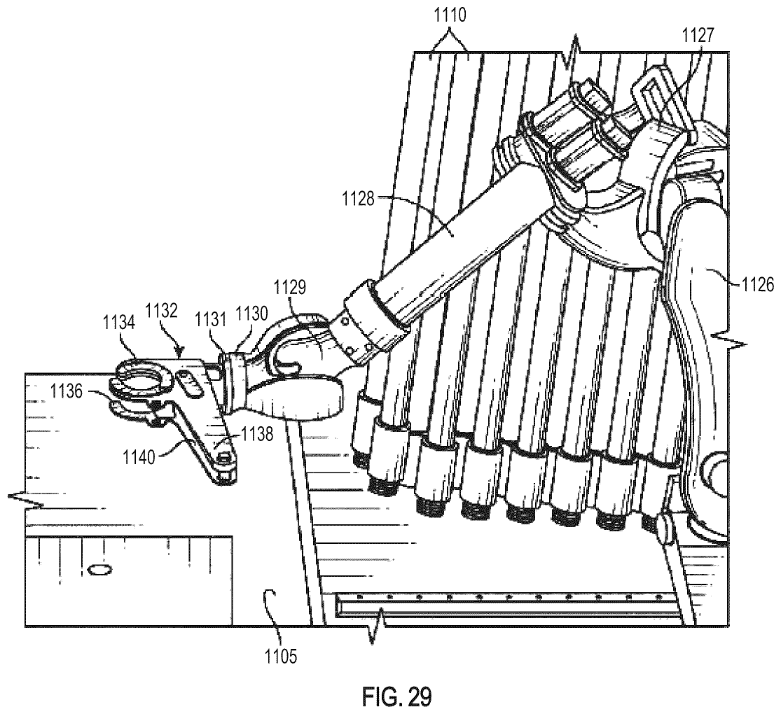

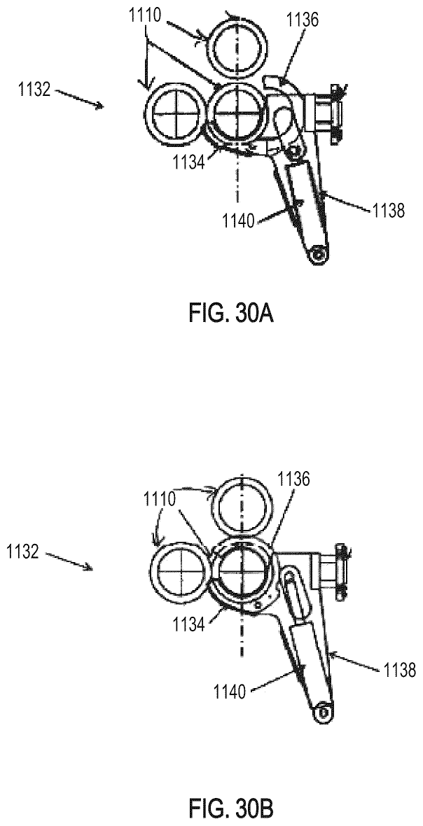

The end effector 1132 may extend from the wrist portion 1130 and may be configured to provide an operational or tooling hand for various operations performed by the robot 1116. For example, in some embodiments, the end effector 1132 may include a movable claw or gripper configured for grasping objects. FIG. 29 shows a close-up view of an end effector 1132. FIGS. 30A and 30B show additional view of the end effector 1132. The end effector 1132 may be configured for handling lengths or stands of drill pipe, drill collar, and/or other piping. As shown in FIG. 29, the end effector 1132 may have a first finger 1134, which may be a fixed or stationary finger, and a second finger 1136, which may be a movable finger. The movable finger 1136 may have a hinged connection to the stationary finger 1134. In some embodiments, the movable finger 1136 may have a hinged connection to a bracket 1138 of the end effector. An actuator 1140, such as a hydraulic cylinder, lead screw mechanism, ball screw mechanism, or other actuator may be configured to pivot the movable finger 1136 about its hinged connection.

The fingers 1134, 1136 may each have a curved shape with an inner contour sized and configured to receive a pipe stand. Inner contours of the two fingers 1134, 1136 may have a same radius of curvature for receiving a same pipe size or range of pipe sizes. The two fingers 1134, 1136 may be arranged such that their inner contours curve toward one another to form a closed or substantially closed loop. The movable finger 1136 may be configured to pivot between an open configuration and a closed configuration. In an open configuration, as shown in FIG. 30A, the movable finger 1136 may pivot away from the fixed finger 1134 such that a pipe stand 1110 may be received between the two fingers. In a closed configuration, the fingers 1134, 1136 may be configured to form a closed loop or partially closed loop, so as to close around an outer wall of a pipe stand 1110.

In some embodiments, the fingers 1134, 1136 may be sized and shaped to receive a particular pipe diameter or a particular range of pipe diameters. In some embodiments, the end effector 1132 may have a coating on one or more surfaces to facilitate handling operations. For example, the end effector 1132 may have a low-friction coating arranged on an inner contour surface of the movable finger and/or fixed finger. A low-friction coating may include wearable fluoro-plastic or another relatively low-friction metallic alloy having a static coefficient of friction against pipe steel of less than 0.2, for example. Other relatively low-friction coatings or materials may be used as well. Such a low-friction coating may facilitate sliding engagement of the end effector with a pipe, for example. In this way, a pipe section may be free to rotate or pivot while engaged by the end effector. In other embodiments, the end effector 1132 may have a high-friction coating or surface to facilitate gripping operations. Other coatings may be used as well.

In some embodiments, the end effector 1132 may be configured to engage with one pipe stand 1110 at a time without disturbing, or substantially without disturbing, adjacent or nearby pipe stands. For example, the movable finger 1136 may have a thickness or width configured to slide between a pair of pipe stands 1110 stored in the racking board 1108 so as to close around a single pipe stand without disturbing an adjacent pipe stand. FIGS. 30A-30B illustrate the end effector 1132 sleeving around a pipe stand 1110. As shown in FIG. 30A, the end effector 1132 may approach the pipe stand 1110 with its movable finger 1136 in an open configuration. With the movable finger 1136 in an open configuration, the robot 1116 may position the fixed finger 1134 around the pipe stand 1110, and may then close the movable finger around the pipe stand, as shown in FIG. 30B. The movable finger 1136 may slide between the pipe stand 1110 and an adjacent pipe stand. In this way, it is to be appreciated that the end effector 1132 may also be configured to position a pipe stand 1110 on the setback area 1105 and/or within the racking board 1108 without disturbing, or substantially without disturbing, other pipe stands stored nearby.

In other embodiments, one or more robots of the present disclosure may have a different end effector or tooling end. In some embodiments, the mechanical interface between the end effector and the wrist portion may allow the end effector to be readily removed by an operator. For example, the mechanical interface may include a threaded connection, clamped connection, a ball and plunger mechanism, and/or any other suitable connection or mechanism allowing for the end effector to be disconnected from the wrist portion on demand. In this way, an operator may remove and replace the end effector as needed.

In some embodiments, the end effector 1132 may have one or more sensors or feedback devices. For example, a proximity sensor or other electromagnetic sensor may be arranged on or about the claw for detecting a presence of a pipe or other object positioned within the claw. Additionally or alternatively, a contact switch or other position sensor may be arranged on or about the claw for detecting an open or closed position of the movable finger 1136. Each robot 1116 may have other sensors and/or feedback devices, such torque feedback devices, proximity sensors, position sensors, and/or other devices or sensors configured to indicate other movements or conditions.

It is to be appreciated that each robot 1116 may have a plurality of movable components and/or a plurality of movement axes with respect to each movable component. In some embodiments, each movable component and/or each axis of movement may be independently controllable and may be configured for coordinate movement with another robot or system. In some embodiments, one or more components or axes of movement may be actively controlled during a pipe handling operation. That is, a controller may be configured to actively control a position of the end effector 1132, wrist portion 1130, articulated arm 1128, and/or other components of the robot(s). In some embodiments, one or both end robot end effectors 1132 may be actively controlled during a pipe handling operation. In particular, a position and angle of the end effector 1132 at joint 1131 may be controlled to maintain a vector extending perpendicularly between the end effector fingers in parallel or near-parallel alignment with the pipe stand. This may help ensure that the end effector 1132 can smoothly grab onto and release the pipe stand. Additionally, this may help to reduce excess torsion on the robots themselves.

In some embodiments, one or more components or axes of movement of the robot(s) may be permitted to experience free movement. For example, in some embodiments, the end effector 1132 of a robot 1116 may be permitted to pivot or rotate freely at joint 1131 with respect to the wrist 1130. In this way, movement at the end effector/wrist joint 1131 may freely respond to a position of the articulated arm 1128 and wrist 1130, a position and angle of a pipe stand 1110 engaged by the end effector 1132, and/or other factors. In particular, to accommodate tilting of the pipe stand 1110, the robot 1116 may be configured or programmed to minimize torque applied by the stand while it is engaged by the end effector 1132. This may be accomplished, for example, by relaxing (i.e., not powering) an actuator controlling position of the joint 1131.

In some embodiments, the pipe handling system may have one or more controllers, each configured for controlling one or more components of the pipe handling system. For example, each of the lifting system, iron roughneck, drill floor robot, and racking board robot may have a controller controlling operations thereof. Each controller may be in wired or wireless communication with one or more associated components of the handling system. For example, a controller may be associated with at least one robot 1116 and may be encoded with instructions for controlling a position of the robot on the track 1124, a position of the shoulder portion 1126, a position of the articulated arm 1128, a position of the wrist 1130, a position of the end effector 1132, and/or a position of the movable finger 1136 or other movable component(s) of the end effector. The controller may additionally be configured to receive feedback from one or more feedback devices or sensors. In some embodiments, the controller may be configured to respond to received feedback or sensor information by, for example, making one or more position adjustments of the robot 1116.

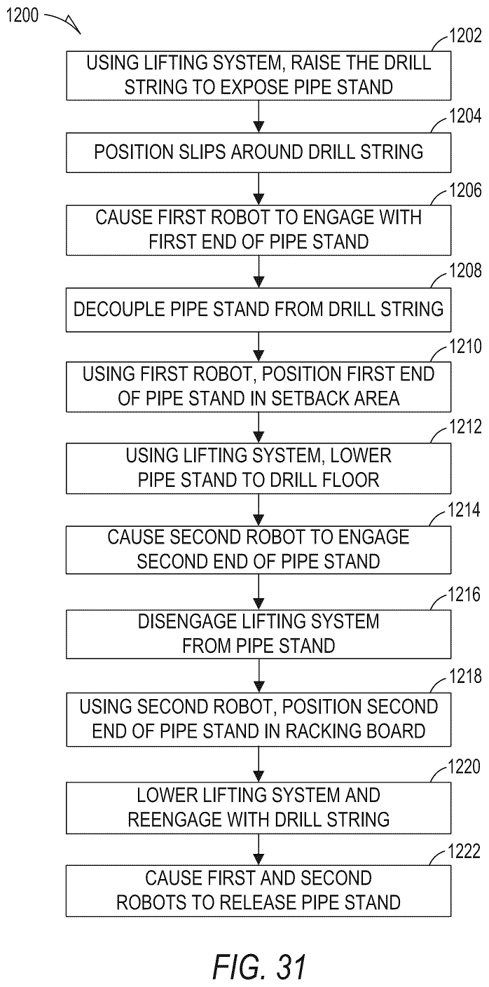

As described in more detail below with respect to particular methods of operation, a pipe handling system of the present disclosure, or components thereof, may be configured to operate as a coordinated system. For example, two robots, such as an upper robot and a lower robot, may operate together to manipulate a single pipe stand, with the upper robot manipulating an upper end of the pipe stand and the lower robot manipulating a lower end of the pipe stand. Movements of the two robots may be coordinated such that the two robots may operate as a team. The two robots may additionally operate in conjunction with operation of a lifting system to handle the load of the pipe stand and to raise/lower the pipe stand as needed to facilitate operations. An iron roughneck may additionally be operated in conjunction with the robots and/or lifting system to perform coordinated operations. This coordination of the various components of a pipe handling system of the present disclosure may be appreciated with particular reference to FIGS. 31-39 and the following discussion.

In use, a pipe handling system of the present disclosure may facilitate drill pipe and/or drill collar handling operations, such as trip in and trip out operations, stand building operations, and/or other pipe handling operations on a drilling rig.

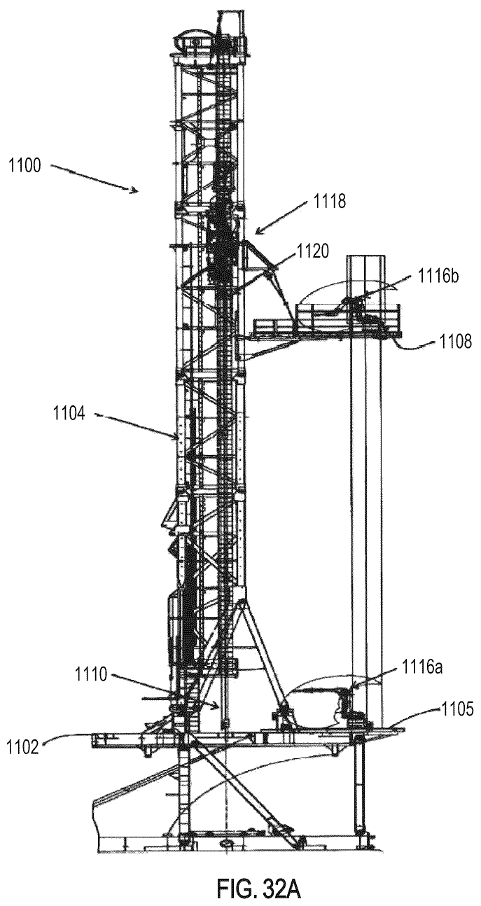

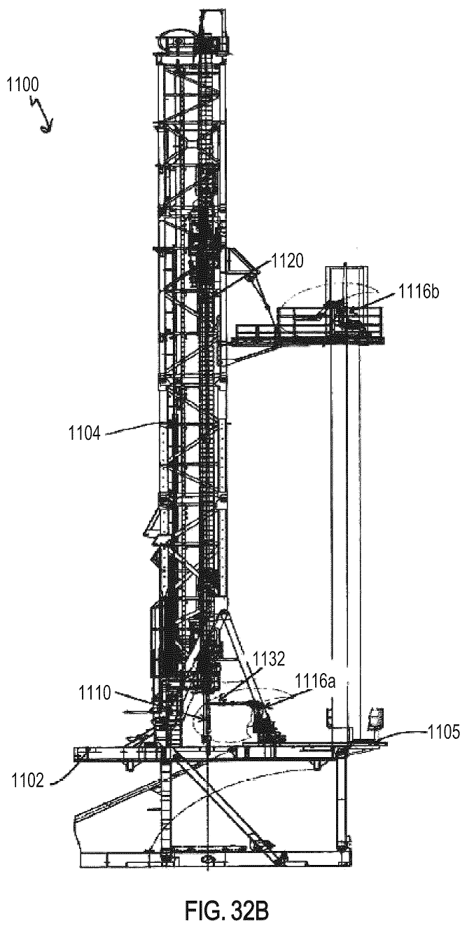

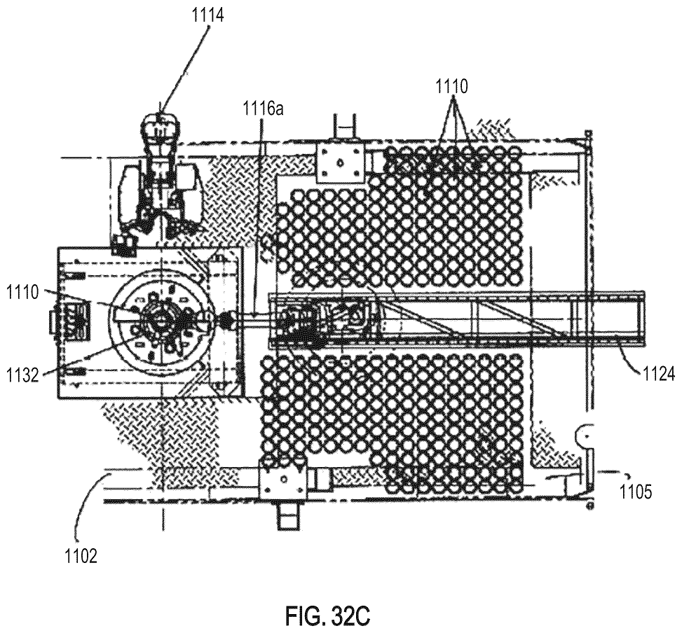

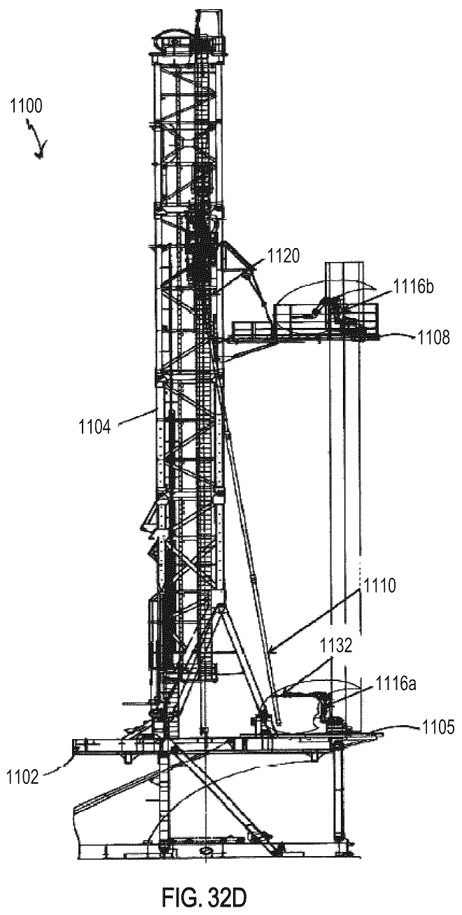

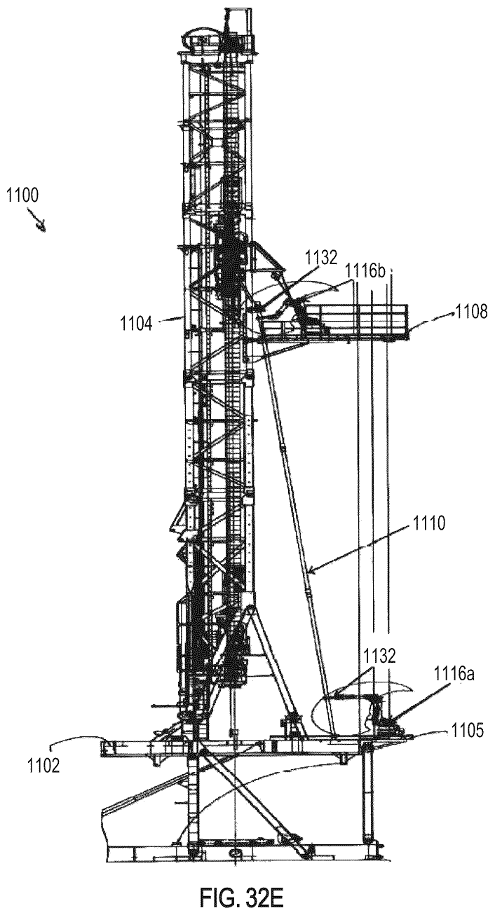

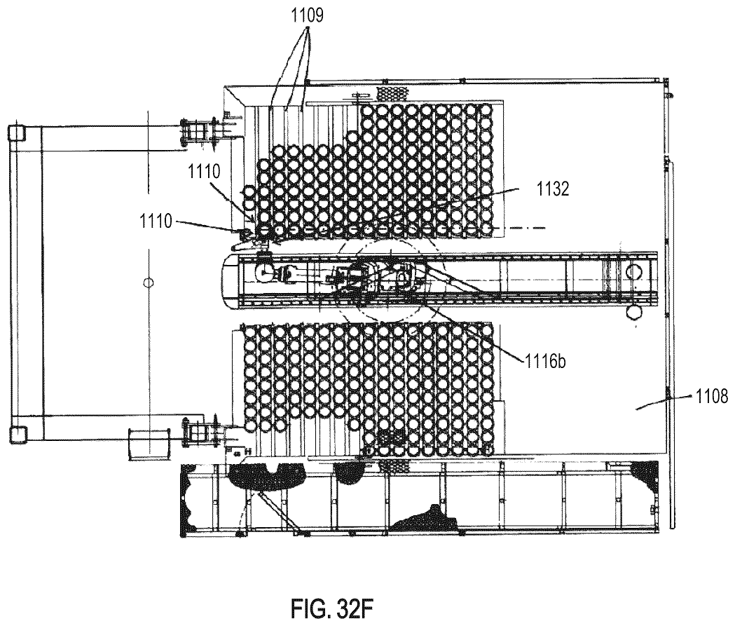

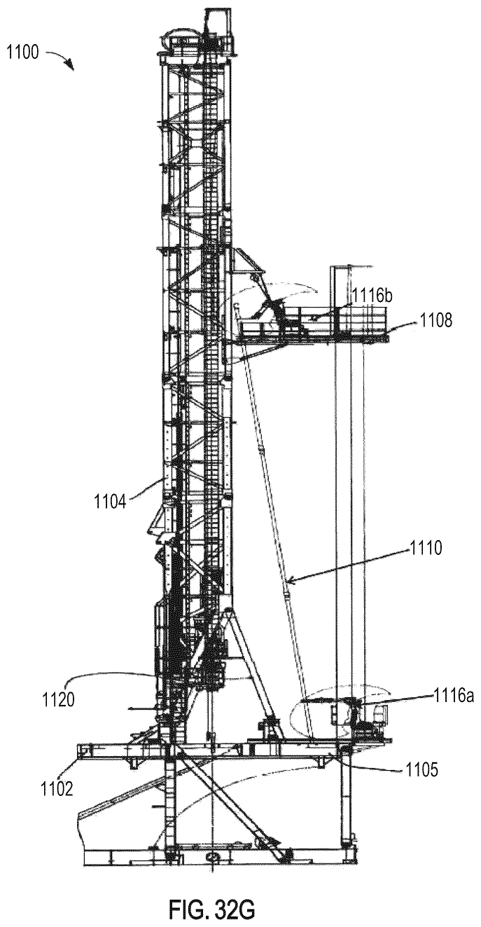

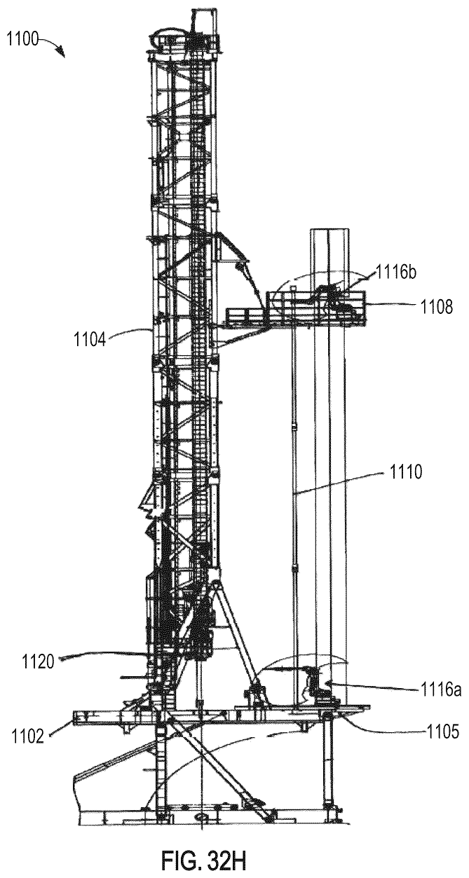

For example, FIG. 31 illustrates a flow diagram of a trip out operation performable using a pipe handling system of the present disclosure, according to one or more embodiments. As described above, a trip out operation may include disconnecting pipe stands from a drill string. A trip out operation may be performed to replace or change out a drill bit or other downhole components, for example. A trip out operation may also be performed after drilling is completed in a well. There may be other reasons to perform a trip out operation as well. The method 1200, or portions thereof, may be encoded on one or more controllers as computer executable instructions. In some embodiments, the method 1200, or portions thereof, may be performable by an operator such as a human operator controlling components of the pipe handling system. The method 1200 may include the steps of using a lifting system, raising the drill string to expose a pipe stand 1202; positioning slips around the drill string 1204; causing a first robot to engage with a first end of the pipe stand 1206; decoupling the pipe stand from the drill string 1208; using the first robot, position the first end of the pipe stand in a setback area 1210; using the lifting system, lowering the pipe stand to the drill floor 1212; causing a second robot to engage a second end of the pipe stand 1214; disengaging the lifting system from the pipe stand 1216; using the second robot, positioning the second end of the pipe stand in a racking board 1218; lower the lifting system and reengage with the drill string 1220; and causing the first and second robots to release the pipe stand 1222. FIGS. 32A-321 illustrate many steps of the method 1200 with respect to the drilling rig 1100.

As described above, the lifting system may be or include an elevator coupled to a traveling block, a lifting hook, a main line, an auxiliary line, an auxiliary lifting arm or claw, and/or any other suitable lifting or hoisting mechanism. In some embodiments, different components of the lifting system, or different lifting systems, may be used for different lifting operations throughout the method or other methods described herein. Raising the drill string (1202) may include raising a pipe elevator, or another suitable lifting apparatus, coupled to the drill string. The lifting system may raise the drill string far enough out of the well to expose above the drill floor a first pipe stand, or length of pipe, to be disconnected from the drill string. FIG. 32A illustrates a pipe elevator 1120 raised high enough to expose a pipe stand 1110 above the drill floor 1102. With the pipe stand exposed, slips may be placed around the drill string (1204) below the pipe stand to maintain a position of the drill string with respect to the drill floor and thus prevent the drill string from falling back into the well. The slips may generally be wedged between an outer diameter of the drill string and an inner diameter of an opening in the drill floor. In some embodiments, the slips may be placed manually by an operator. In other embodiments, a robot may be used to position the slips. In other embodiments, another suitable mechanism for holding a position of the drill string may be used.

With the pipe stand exposed, a first robot, which may be a lower robot positioned on or near the drill floor, may be directed to engage with a first end of the pipe stand (1206). The first end of the pipe stand may be an end of the stand located nearest the drill floor and coupled to the remainder of the drill string. The first end of the pipe stand may be referred to herein as a lower end. To engage with the pipe stand, the drill floor robot may be directed to move, on its track or other moving mechanism, toward well center. The articulated arm may be used to reach toward the pipe stand. FIG. 32B illustrates the lower robot 1116a arranged on the drill floor 1102 and positioned to engage the pipe stand. As additionally shown in FIG. 32B, the end effector 1132 of the lower robot 1116a may be controlled to grasp the lower end of the pipe stand 1110. In particular, the end effector may be controlled to open or extend the movable finger, position the pipe stand between the movable finger and the fixed finger, and close or retract the movable finger. FIG. 32C shows an overhead view of the lower robot 1116a with its end effector 1132 engaged around the pipe stand 1110. Decoupling the exposed pipe stand from the remainder of the drill string (208) may include directing an iron roughneck to disconnect the pipe stand. FIG. 32C shows an iron roughneck 1114 arranged on the drill floor 1102 that may be used to decouple the drill exposed pipe stand 1110 from the drill string. In other embodiments, a robot or one or more operators may disconnect the pipe stand from the drill string. It is to be appreciated that with the pipe stand disconnected from the drill string, the pipe elevator or other lifting system may still be supporting the weight of the pipe stand.

With the pipe stand disconnected from the drill string, the first robot may move to position the first end of the pipe stand in the setback area of the drill floor, beneath the racking board (1210). In particular, the first robot may move along its track or other moving apparatus away from the well center to a setback area of the drill floor. The articulated arm may move to position the lower end of the pipe stand beneath the racking board. In some embodiments, the first robot may position the lower end of the pipe stand aligned with or near a particular racking location where the pipe stand is to be stored in the racking board. FIG. 32D illustrates the lower robot 1116a positioning the lower end of the pipe stand 1110 beneath the racking board 1108. The lifting system may be used to lower the pipe stand to the drill floor (1212), so as to transfer the load of the pipe to the drill floor. The lower end of the pipe stand may be lowered to a particular location in the setback area, as positioned by the lower robot, where the pipe stand will be stored with respect to the racking board. In one or more embodiments, the elevator 1120 may swing laterally away from well center to move the top of the pipe stand closer to the racking board and helping to facilitate placement of the bottom of the pipe stand in the set back area.

Additionally, the second robot, which may be an upper robot arranged on or near the racking board, may be directed to engage a second end of the pipe stand (1214). The second end of the pipe stand may be an end opposing the first end, arranged furthest from the drill floor and/or nearest the racking board. The second end of the pipe stand may be referred to herein as the upper end. To engage with the pipe stand, the upper robot may be directed to move, on its track or other moving mechanism, toward well center. The articulated arm may be used to reach toward the pipe stand. FIG. 32E illustrates the upper robot 1116b arranged on the racking board 1108 and positioned to engage an upper end of the pipe stand 1110. As shown in FIG. 32E, the end effector 1132 of the upper robot 1116b may be controlled to grasp the upper end of the pipe stand. In particular, the end effector may be controlled to open or extend the movable finger, position the pipe stand between the movable finger and the fixed finger, and close or retract the movable finger. Moreover, the wrist and/or other aspects of the second robot may be manipulated to position the end effector in a manner that accommodates the angle of the pipe stand based on the position of the top and bottom of the pipe, which may be known based on the first robot position and the elevator position. With both ends of the pipe stand engaged by the first and second robots, and with the weight of the pipe stand supported by the drill floor, the pipe elevator or other lifting system may be disengaged from the pipe stand (1216). Additionally, the upper robot may move to position the upper end of the pipe stand within the racking board, such as between two fingers of the racking board (1218). The upper robot may position the upper end of the pipe stand in line with the lower end of the pipe stand as positioned by the lower robot. FIG. 32F illustrates an overhead view of the upper robot 1116b positioning the pipe stand 1110 within the fingers 1109 of the racking board 1108. In one or more embodiments, the end effectors of the first and second robots may be manipulated to track and/or follow the changing angle of the pipe stand as the second robot moves the top of the stand into the fingers of the racking board.

After it disengages from the pipe stand, the lifting system may be lowered to begin a next tip out sequence. In particular, the lifting system may be lowered and may reengage the drill string (1220). If slips were placed, they may be removed from around the drill string, and the lifting system may repeat the method 1200 by raising the drill string to expose another pipe stand. FIG. 32G illustrates the lifting system lowering the pipe elevator 1120 to reengage the drill string while the lower 1116a and upper 1116b robots manipulate the pipe stand 1110 to a stored position between the setback area 1105 and the racking board 1108. It is to be appreciated that the weight of the pipe stand 1110 may be directed to the drill floor 1102 while the upper robot 1116b manipulates the upper end of the pie stand, as shown in FIG. 32G. Additionally, the first and second robots may release the pipe stand once it is positioned in the racking board and may move toward well center to engage with a next pipe stand (1222). FIG. 32H illustrates the pipe stand 1110 stored in the setback area 1105 and racking board 1108, as the lower robot 1116a disengages from the pipe stand 1110 and moves toward well center to approach a next pipe stand.

In some embodiments some steps of the method 1200 may be performed simultaneously or substantially simultaneously. For example, the lifting system may lower the pipe stand toward the drill floor while the lower robot moves to position the lower end of the pipe stand in the setback area, and while the upper robot moves toward well center in preparation for engagement with the upper end of the pipe stand. Additionally, operations of the various components of the pipe handling system may be coordinated together to carry out the method steps. In some embodiments, actions of the various components may be coordinated by timing individual steps or operations with respect to one another. Additionally or alternatively, operations of the various components may be coordinated based upon feedback data received from one or more components. For example, a weight sensor on or arranged in connection with the lifting system may provide an indication as to whether the pipe stand is held within the pipe elevator. As another example, a contact switch arranged on or in connection with each robot end effector may provide an indication a to whether the pipe stand is engaged by the end effector. A proximity sensor arranged on or in communication with each end effector may provide an indication as to whether the end effector is in an open or closed position. Still further, rotational motion of the several joints of the robots may be measured or monitored as the robot moves so as to continually track the position and orientation of the end effectors and, thus, the portion of the pipe stand surrounded by the end effector. Some steps or operations of methods of the present disclosure may be performed based upon such feedback data, as is described in more detail below.

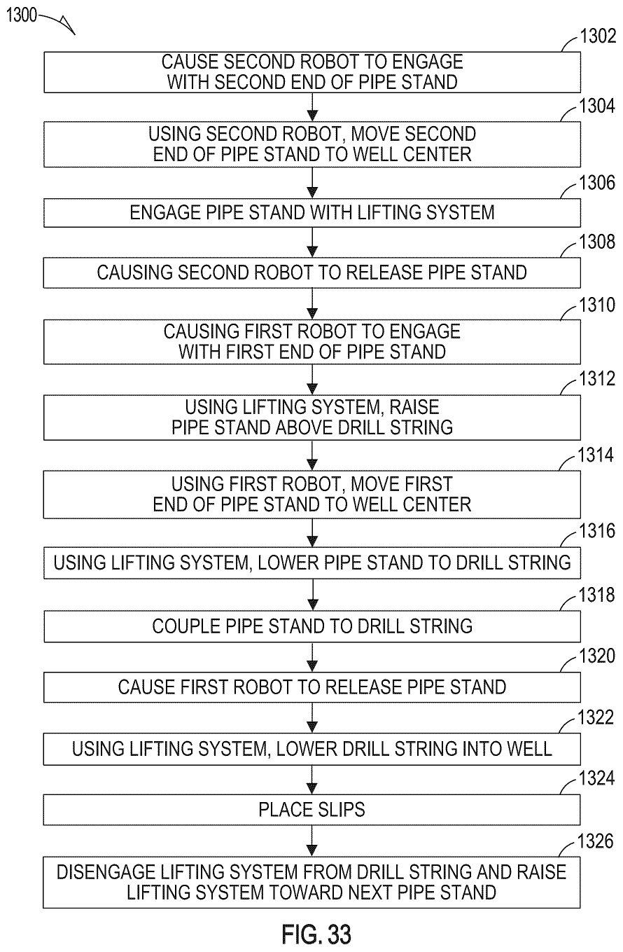

FIG. 33 illustrates a flow diagram of a trip in operation performable using a pipe handling system of the present disclosure, according to one or more embodiments. The method 1300 may be performed automatically, partially automatically, manually, or partially manually. The method 1300, or portions thereof, may be encoded on one or more controllers as computer executable instructions. In some embodiments, the method 1300, or portions thereof, may be performable by an operator such as a human operator controlling components of the pipe handling system. The method 1300 may include the steps of causing the second (upper) robot to engage with the second (upper) end of a pipe stand (1302); moving the second end of the pipe stand toward well center (1304); using a lifting system, engaging the pipe stand with the lifting system (1306); causing the second robot to release the pipe stand (1308); causing the first (lower) robot to engage with the first (lower) end of the pipe stand (1310); using the lifting system, raising the pipe stand (1312); moving the first end of the pipe stand toward well center (1314); lowering the pipe stand onto the drill string (1316); coupling the pipe stand to the drill string (1318); causing the first robot to release the pipe stand (1320); lowering the elevator with the drill string (1322); placing slips around the drill string (1324); and disengaging the lifting system from the drill string and raising the lifting system toward a next pipe stand (1326). It is to be appreciated that a trip in operation may effectively be a reverse of a trip out operation, and thus many steps of the method 300 may be understood with reference to FIGS. 32A-32H in reverse order. It is to be appreciated that the nomenclature of the first and second robots, as indicated with respect to the method 1200, is maintained with respect to the method 1300.

The second robot, which may be an upper robot arranged on or near the racking board, may engage with the second or upper end of a pipe stand (1302). This may be a pipe stand stored in the setback area of the drill floor and arranged within the racking board. The robot may engage with the pipe stand by grasping it with the end effector. In some embodiments, the robot may be directed to the pipe stand based on a known location of the pipe stand. That is, the robot may be directed to open and close the end effector at a particular location above the racking board, where it is known that a pipe stand is stored. Alternatively or additionally, the robot may include sensors for determining the position of the pipe stand. As described above, the robot may be configured to engage with a single pipe stand without disturbing surrounding pipe stands stored nearby.

With the pipe stand engaged by the end effector, the upper robot may move the engaged upper end of the pipe stand toward well center (1304). The upper robot may move along its track or other movement means on the racking board, and/or may use the articulating arm to position the upper end of the pipe stand at or near well center. It is to be appreciated that while the upper robot maneuvers the upper end of the pipe stand, the weight of the pipe stand may be held by the drill floor. The second robot may thus position the upper end of the pipe stand so that it may be lifted by a lifting system. A pipe elevator or other lifting system may engage the pipe stand to transfer the load from the drill floor (1306). The upper robot may release its grip on the pipe stand (1308), thus completing a hand-off from the upper robot to the pipe elevator.

Additionally, the first robot, which may be a lower robot arranged on or near the drill floor, may engage with a lower end of the pipe stand, which may be arranged within the setback area of the drill floor (1310). As described above, the first robot may engage the pipe stand without disturbing nearby pipe stands. Moreover, the first robot may adjust its end effector to accommodate the changed positioned of a portion of the pipe which may be slightly above the bottom due to the tilted nature of the pipe created by moving the top of the pipe to the pipe elevator or lifting system. The lifting system may operate to lift the pipe stand, so as to transfer the weight of the stand from the drill floor to the lifting system (1312). With the weight of the pipe stand held by the lifting system, the lower robot may move the lower end of the pipe stand toward the well center, and in some embodiments may position the lower end of the pipe stand over the drill string extending from the well (1314). As the lower robot moves the lower end of the pipe, the end effector on the lower robot may continually track the position and orientation of the pipe based on knowledge of the top and bottom positions of the pipe and may adjust the end effector to accommodate the continually changing pipe orientation. The lifting system may lower the pipe stand onto the drill string (1316), and the pipe stand may be coupled to the drill string using, for example, an iron roughneck (1318). The lower robot may release the lower end of the pipe stand (1320).

In some embodiments, slips or another mechanism holding the drill string in place with respect to the drill floor may be removed or disengaged, and the lifting system may operate to lower the drill string so as to lower the newly attached pipe stand at least partially into the well (1322). Slips or another suitable mechanism may be positioned around the drill string to maintain a position with respect to the drill floor (1324). With a position of the drill string held by the slips, the lifting system may disengage from the drill string, and may raise upward toward the racking board to prepare for engagement with a next pipe stand (1326). The method 1300 may thus repeat in order to attach a next pipe stand to the drill string.

As described above with respect to the method 1200, some steps of the method 1300 may be performed simultaneously or substantially simultaneously. Additionally, operations of the various components of the pipe handling system may be coordinated together to carry out the method steps. In some embodiments, actions of the various components may be coordinated by timing individual steps or operations with respect to one another. Additionally or alternatively, operations of the various components may be coordinated based upon feedback data received from one or more feedback devices, such as a weight sensor, a contact switch, a proximity sensor, and/or other suitable feedback devices.

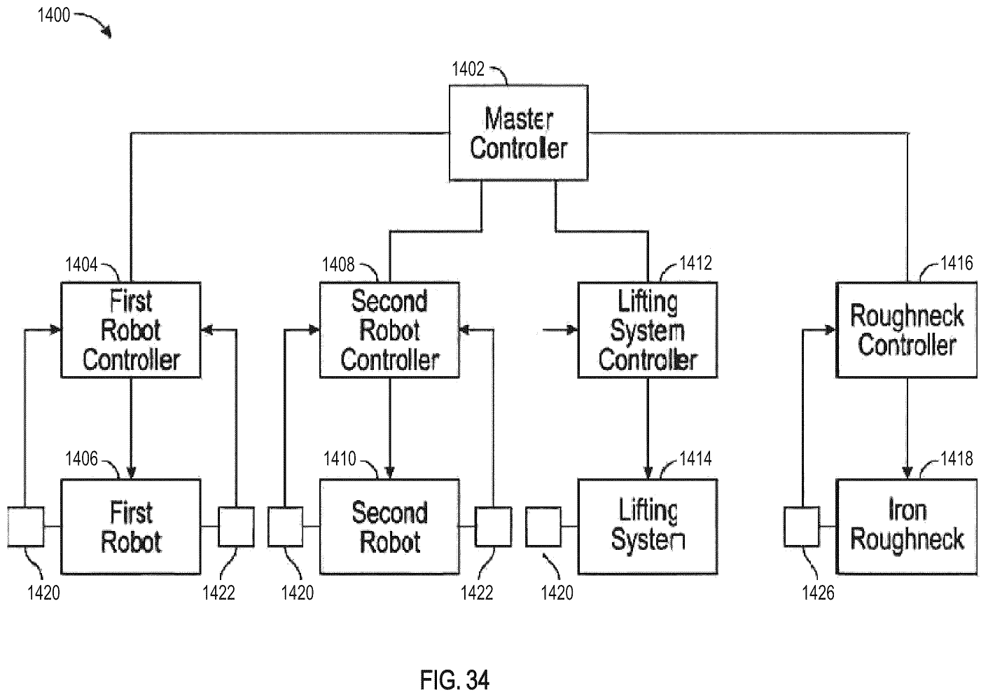

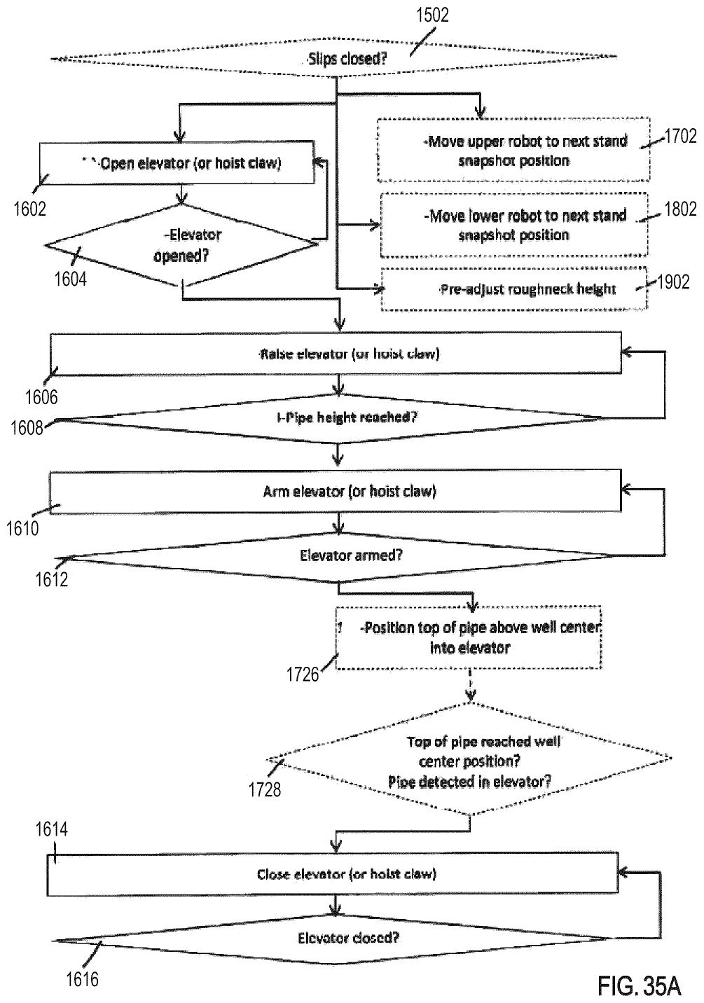

FIG. 34 shows one embodiment of a system 1400 of the present disclosure, according to one or more embodiments. The system 1400 may be configured to perform one or methods of the present disclosure. As shown in FIG. 34, the system 1400 may include a master controller 1402 in communication with one or more device controllers. For example, in some embodiments, a system 1400 of the present disclosure may include a first robot controller 1404 for controlling operations of a first robot 1406, such as a lower or drill floor robot. The system 1400 may additionally have a second robot controller 1408 for controlling operations of a second robot 1410, such as an upper or racking board robot. For each robot, the corresponding robot controller may be programmed or otherwise configured for controlling movement of the robot on its track or other movement system, movement of the shoulder portion with respect to the base portion, movement of the articulated arm with respect to the shoulder portion, movement of the wrist portion with respect to the articulated arm, movement of the end effector with respect to the wrist portion, and actuation of the movable finger or other end effector component(s). The system 1400 may have a lifting system controller 1412 for controlling operations of a lifting system 1414. For example, the lifting system controller 1412 may be programmed or otherwise configured for controlling a draw works in order to raise and lower a traveling block and pipe elevator on a main or auxiliary line. The system may have a roughneck controller 1416 for controlling operations of an iron roughneck 1418. The roughneck controller 1416 may be programmed or otherwise configured to control movement of the roughneck 1418 along a drill floor as well as spinning and torque movements, or other mechanisms, used to couple sections of a drill string. It is to be appreciated that in other embodiments, a system of the present disclosure may have more or fewer controllers or sub-controllers. For example, in some embodiments, a single controller may be programmed or otherwise configured to control operations of all the components without individual component controllers.

The system 1400 may additionally include one or more feedback devices or sensors configured to gather or measure information and send feedback data to one or more controllers. For example, one or more robots 1406, 1410 may have a contact switch 1420 configured to identify whether a movable finger of an end effector is in an open position or a closed position. For each robot 1406, 1410, the contact switch 1420 may send data to the controller 1404, 1408 controlling that robot. In this way, the controller 1404, 1408 may control some operations of the robot 1406, 1410 based on a determination of whether the movable finger is open or closed. One or more robots 1406, 1410 of the system may additionally or alternatively have a proximity sensor 1422 configured to identify whether an object is grasped by the end effector or otherwise in close proximity to an inner curved surface or other surface of the end effector. Each proximity sensor 1422 may send data to the controller 1404, 1408 for the corresponding robot. Robots 1406, 1410 may additionally have position sensors or other sensors configured to help coordinate movement between the two robots, such that each robot can respond to and coordinate with movements and operations of the other robot while handling a pipe stand. A weight sensor 1424 may be arranged on or in communication with the lifting system 1414. For example, the weight sensor 1424 may be positioned on a main line, traveling block, or pipe elevator. The weight sensor 1424 may be configured to determine whether there is a load acting on the lifting system 1414, such as the weight of a pipe stand. The weight sensor 1424 may communicate sensed data to the lifting system controller 1412. The system 1400 may additionally have one or more sensors 1426 associated with the iron roughneck 1418, such as a proximity sensor, torque sensor, or other suitable sensor or feedback device in communication with the roughneck controller 1416. The system may have additional or alternative feedback devices or sensors. For example, the system may include a feedback device associated with slips provided at the well center to indicate whether the slips are closed around the drill string. Feedback devices and sensors may send sensed data to controllers continuously, at intervals, intermittently, or on demand. In some embodiments, a controller may query a feedback device or sensor for data as needed.

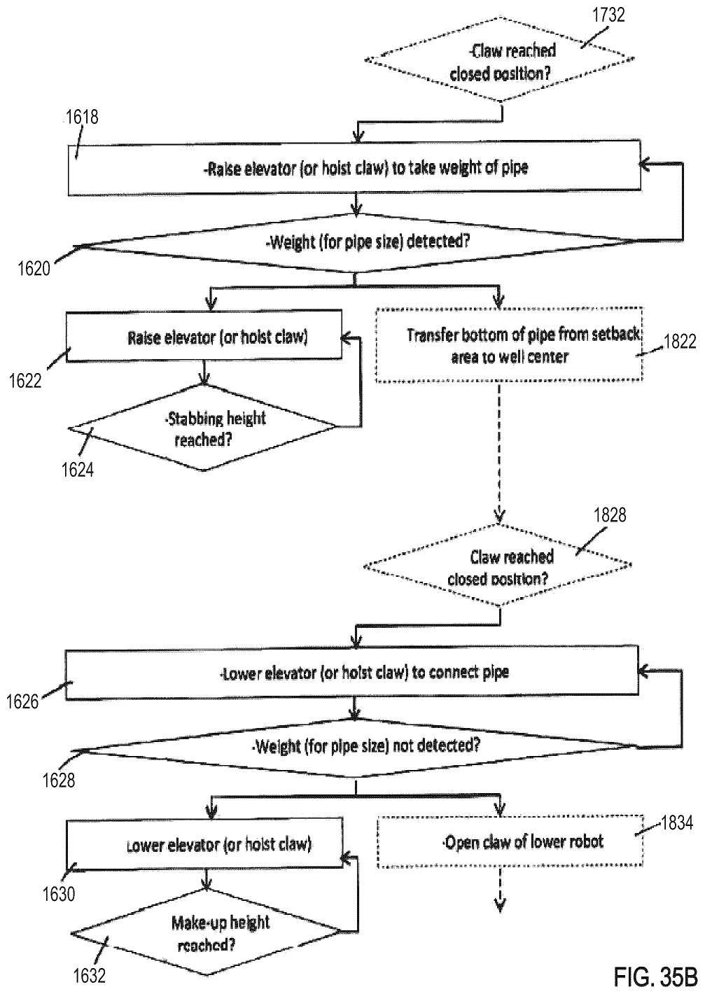

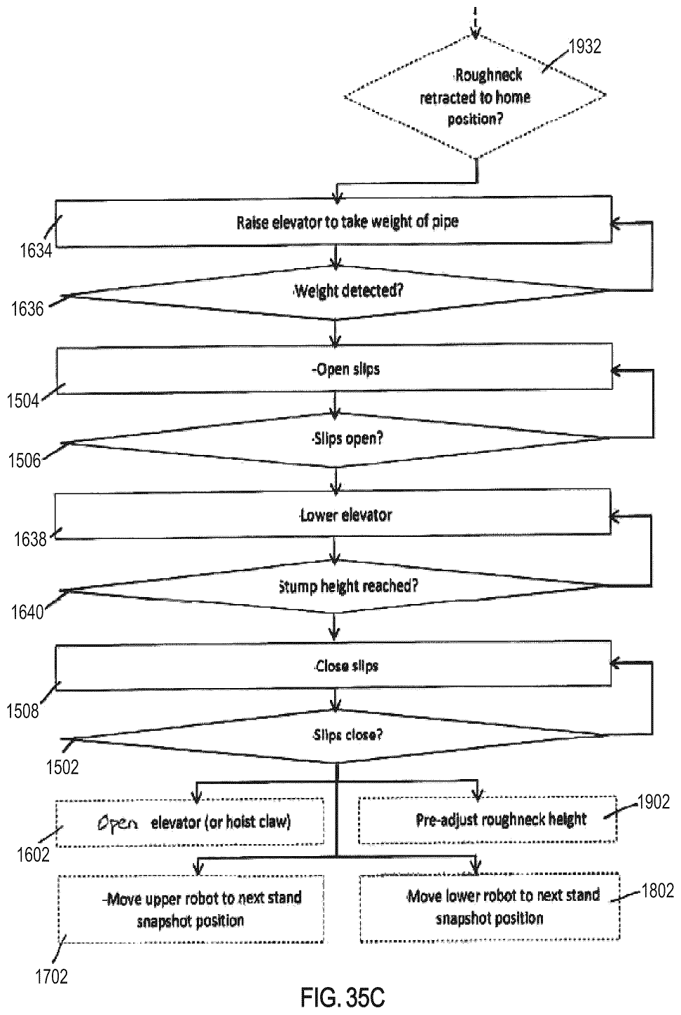

In some embodiments, steps of the methods and/or other operations described herein may be programmed as, or may include or be part of, one or more finite state machines. A finite state machine sequence of operations may be performable by one or more controllers. FIGS. 35-38 illustrate steps performable by each of a lifting system controller, upper robot controller, lower robot controller, and iron roughneck controller, respectively, for a trip in operation according to some embodiments.

For example and as shown in FIG. 35A, a first state for each component may depend on an indication of whether slips are closed around a drill string 1502. Such indication may be determined based on a feedback device in communication with the slips. In other embodiments, the indication may be supplied by an operator or by any other suitable means. If it is determined that the slips are closed 1502, the lifting system controller may direct the lifting system to open the elevator at state 1602. Additionally, if the slips are closed 1502, the upper robot controller may direct the upper robot to move to a next pipe stand snapshot position at state 1702. If the slips are closed 1502, the lower robot controller may direct the lower robot to move to a next pipe stand snapshot position at state 1802. If the slips are closed 1502, the roughneck controller may direct the iron roughneck to pre-adjust the roughneck height to a stump height of the drill string to prepare for a coupling operation at state 1902. Each of the controllers may then proceed through a plurality of states based, at least in part, on feedback data received.

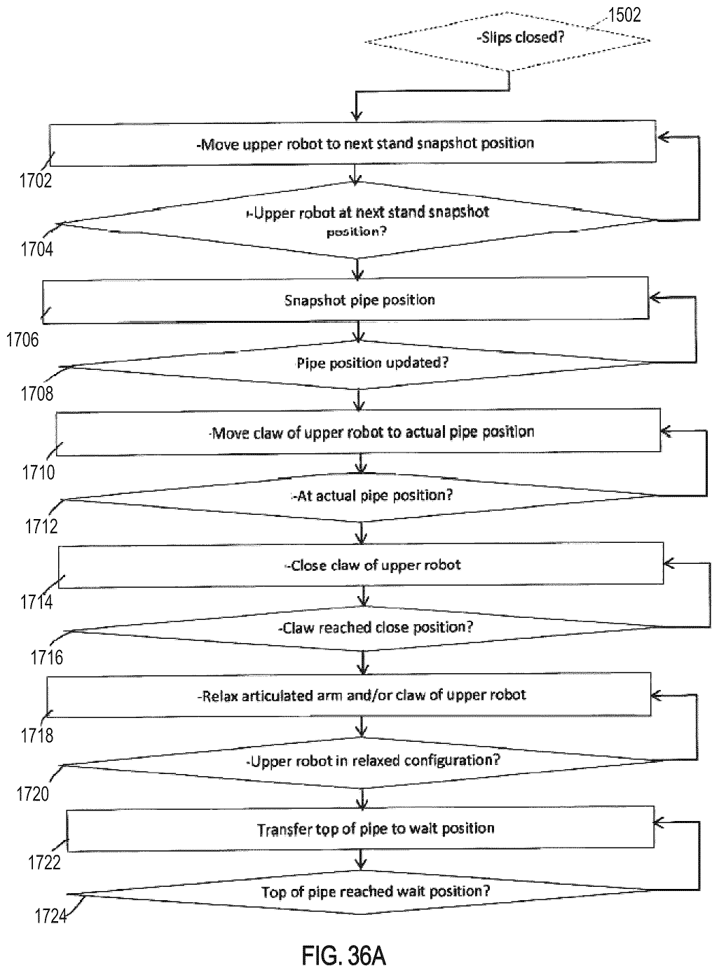

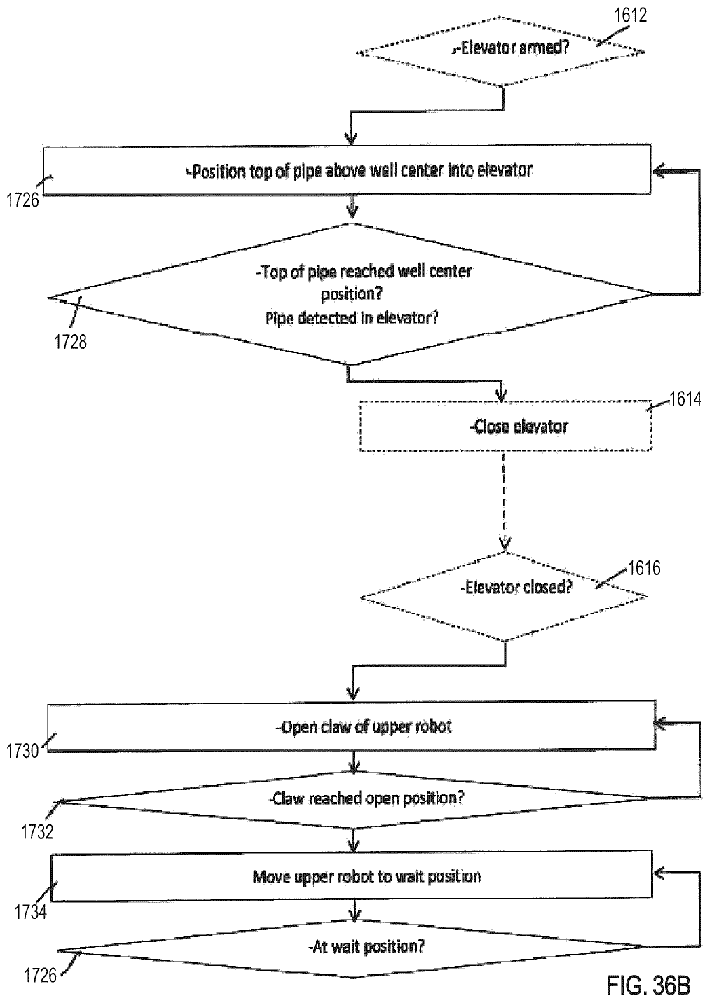

With reference to FIGS. 35A-35C, if a feedback device or other indication means indicates that the pipe elevator is open 1604, the lifting system controller may direct the lifting system to raise the elevator 1606. If, however, it is determined that the elevator is not open, the controller may return to, or maintain, state 1602 until it is determined that the elevator is open. If a feedback device or other indication means indicates that the elevator has reached a pipe stand height 1608, the controller may direct the lifting system to arm the elevator 1610. If it is determined that the elevator is armed 1612 based on a feedback device or other feedback means, a step of positioning an upper end of the pipe stand into the elevator 1726 may be performed by an upper robot controller, as discussed in more detail below with respect to FIGS. 36A-36B. If it is determined based on a feedback device or other feedback means that the elevator is armed 1612 and the pipe stand is detected in the elevator 1728, the controller may direct the elevator to close on the pipe stand 1614. If it is determined that the elevator is closed 1616 and a claw of the upper robot is in a closed position 1732, the controller may raise the elevator to take the weight of the pipe stand 1618. Once the weight of the pipe stand is detected 1620 within the lifting system, the controller may raise the elevator 1622 until a stabbing height is reached 1624 for stabbing the pipe stand into the drill string. Once the elevator reaches a stabbing height 1624 and a claw of the lower robot is closed 1828, the controller may lower the elevator to connect the pipe stand to the drill string 1626. If it is detected that the elevator no longer holds the weight of the pipe 1628, the controller may lower the elevator 1630 until a make-up height is reached 1632. Once the make-up height is reached 1632 and the roughneck is retracted to a home position 1932, the controller may raise the elevator 1634. Once the weight of the pipe (or drill string) is detected within the elevator 1636, the slips may be opened 1504. Slips may be controllable by a same controller as the lifting system and/or other components of the system, or may be controlled by another controller or mechanism. In some embodiments, the slips may be controlled manually or partially manually. Once the slips are open 1506, the elevator may be lowered 1638 until a stump height is reached 1640. Once the stump height is reached 1640, the slips may be closed 1508. The trip in operations of each of the systems may then repeat to connect another pipe stand. In particular, as shown in FIG. 35C, if it is determined at step 1502 that the slips are closed, the elevator may be opened 1602, the upper and lower robots may be directed to a next pipe stand snapshot position 1702, 1802, and a roughneck height may be pre-adjusted 1902.

With reference to FIGS. 36A-36B, if a feedback device or other indication means indicates that the upper robot has moved to a snapshot position 1704, the controller may direct the upper robot to snapshot the pipe stand position within the racking board 1706 using a camera, proximity sensors, and/or other sensors to indicate an actual pipe stand position within the racking board. Based on feedback from such devices indicating an updated position of the pipe stand 1708, the controller may direct the claw of the robot to the actual pipe stand position 1710. If it is determined that the claw of the upper robot has reached the actual pipe stand position 1712, the controller may close the claw of the upper robot around the pipe stand 1714. Based on an indication that the claw is in a closed position 1716, the controller may relax the articulated arm and/or claw of the upper robot 1718. When it is determined that the upper robot or portions thereof are in a relaxed configuration 1720, the controller may direct the upper robot to move the pipe stand to a wait position near the well center 1722. Once the upper end of the pipe stand is in the wait position 1724 and the elevator is armed to receive the pipe stand 1612, the controller may direct the upper robot to position an upper end of the pipe stand in the elevator 1726. When the pipe stand is detected in the elevator and the elevator 1728 and the elevator is closed 1616, the controller may direct the upper robot to release the pipe stand 1730. Based on a determination that the claw of the upper robot is open 1732, the controller may direct the upper robot to a wait position 1734 and may then verify whether the robot has reached the wait position 1736.

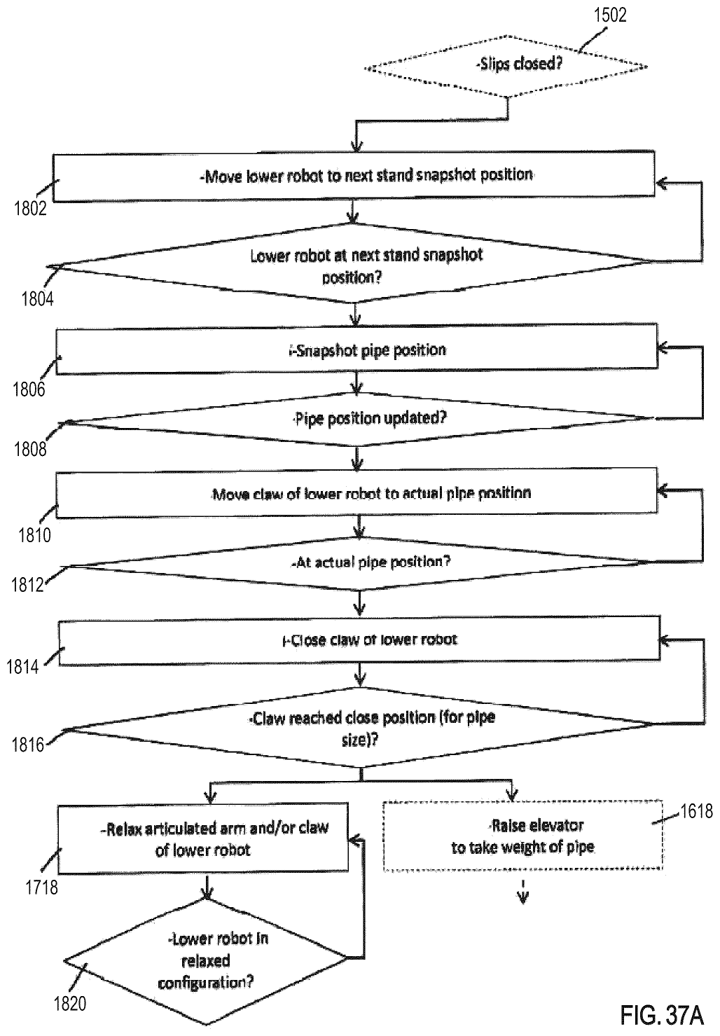

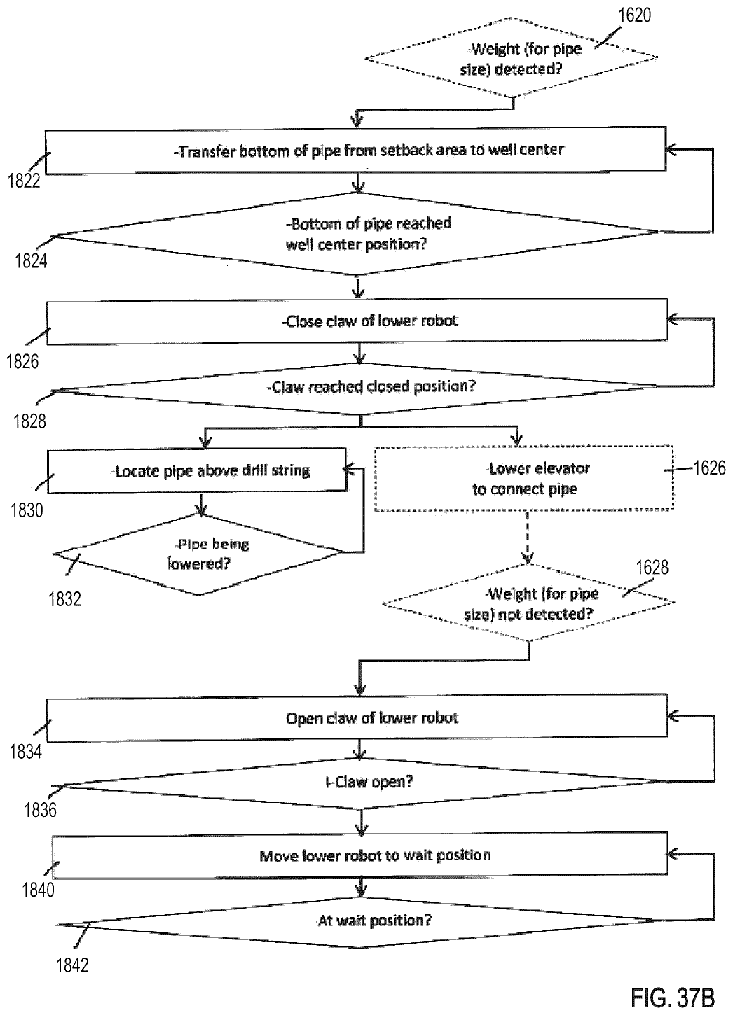

With reference to FIGS. 37A-37B, if a feedback device or other indication means indicates that the lower robot is at a next pipe stand snapshot position 1804, the controller may direct the lower robot to take a snapshot of the actual pipe stand position 1806. Based on snapshot data indicating an actual pipe stand position 1808, the controller may direct the claw of the lower robot to the actual pipe stand position 1810. When the claw reaches the actual pipe stand position 1812, the controller may close the claw of the lower robot 1814. When it is determined that the claw of the lower robot is in a closed position 1816, the controller may direct the lower robot to relax its articulated arm and/or claw 1818 and, as indicated above, the lifting system may be directed to raise the elevator so as to take the weight of the pipe stand 1618. Once the lower robot is in a relaxed configuration 1820 and the weight of the pipe is detected within the pipe elevator 1620, the controller may direct the lower robot to transfer a lower end of the pipe stand from the setback area to well center 1822. Once the lower end of the pipe reaches the well center position 1824, the controller may close the claw of the lower robot 1826. With an indication that the claw is closed 1828, the controller may direct the lower robot to position the pipe stand above the drill string 1830. At or near the same time, the lifting system may be directed to lower the pipe elevator to lower the pipe stand onto the drill string 1626. The lower robot may continue to position the lower end of the pipe stand above the drill string as the elevator lowers the stand toward the drill string 1832. Once it is determined that the elevator no longer holds the weight of the pipe stand 1628, the controller may open the claw of the lower robot 1834. Once the claw of the lower robot is detected in an open position 836, the lower robot may be directed to a wait position 1840 and may then verify whether the robot has reached the wait position 1842.

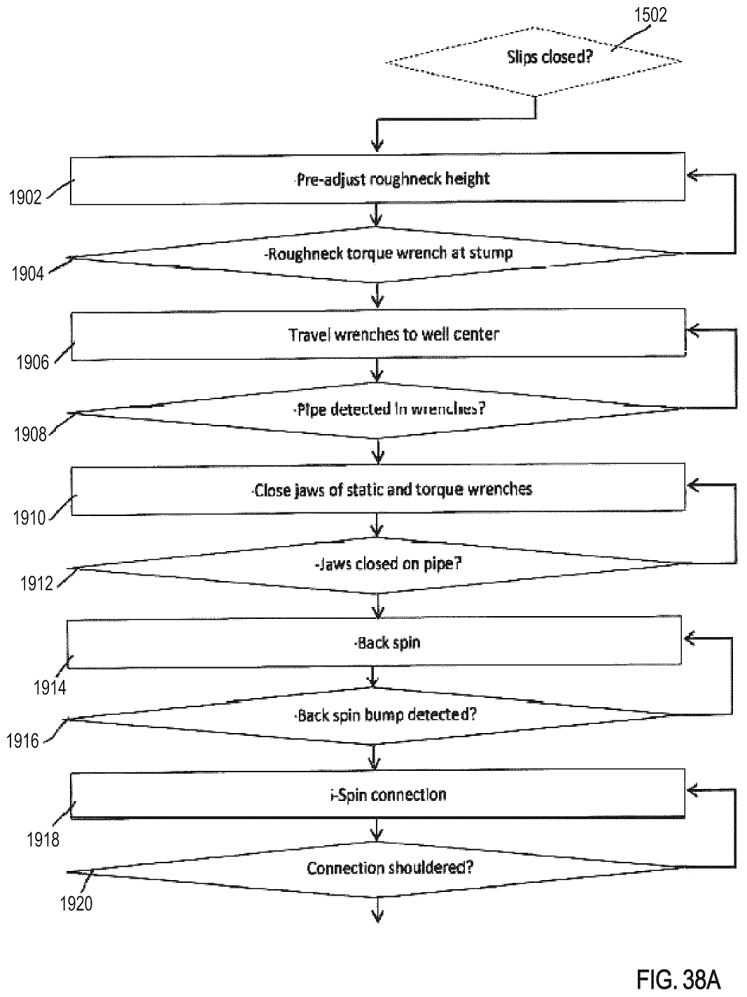

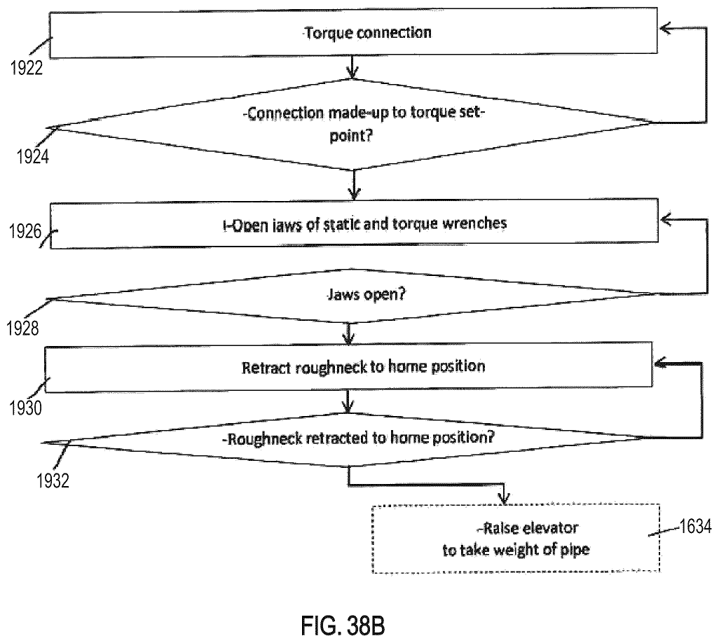

With reference to FIGS. 38A-38B, if a feedback device or other indication means indicates that a torque wrench of the roughneck has reached a stump height of the drill string 1904, the controller may direct the roughneck on the drill floor to a position at well center adjacent the drill string 1906. Upon detecting that the drill string and/or lower end of the pipe stand are positioned within roughneck wrenches 1908, the controller may close the jaws of static and torque wrenches of the roughneck 1910. Once it is determined that the jaws are closed 1912, the controller may direct a back spin of the torque wrench of the iron roughneck 1914. Upon detection of a back spin bump 1916, the controller may spin the torque wrench of the iron rough neck 1918 to couple the pipe stand and drill string together. Upon an indication that a threaded connection between the drill string and pipe stand is shouldered 1920, the controller may direct the roughneck to torque the connection 1922. Upon an indication a torque set-point is reached 1924, the controller may direct the jaws of the roughneck wrenches to open 1926. Upon an indication that the jaws are open 1928, the controller may retract the roughneck to a home position on the drill floor 1930. With the roughneck in the home position 1932, the elevator may be raised to take the weight of the pipe stand and drill string 1634 in preparation for lowering the drill string, and as discussed with respect to FIG. 35C.

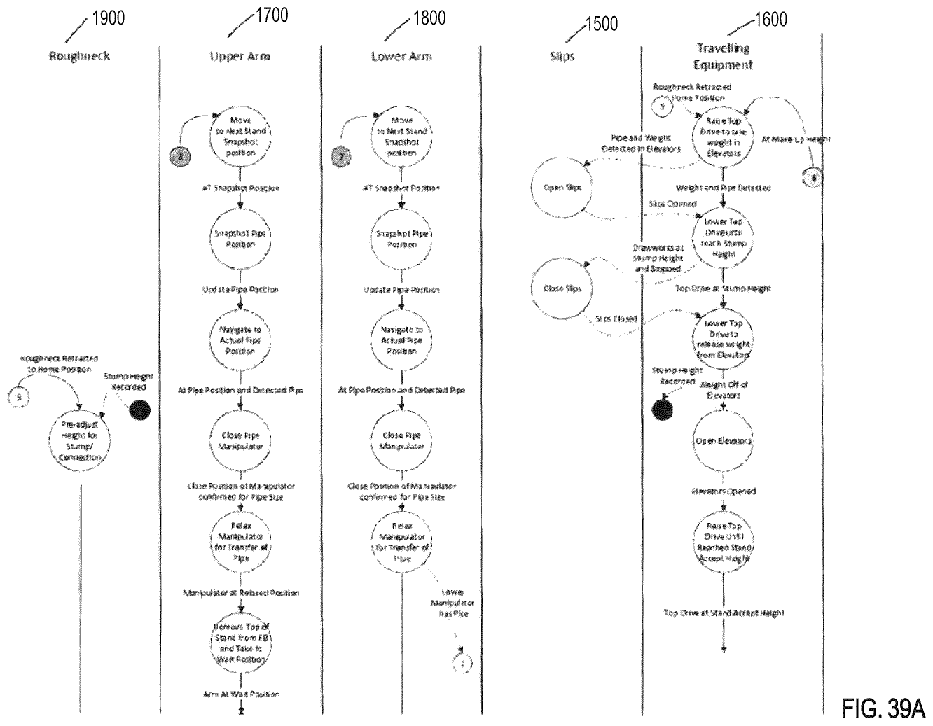

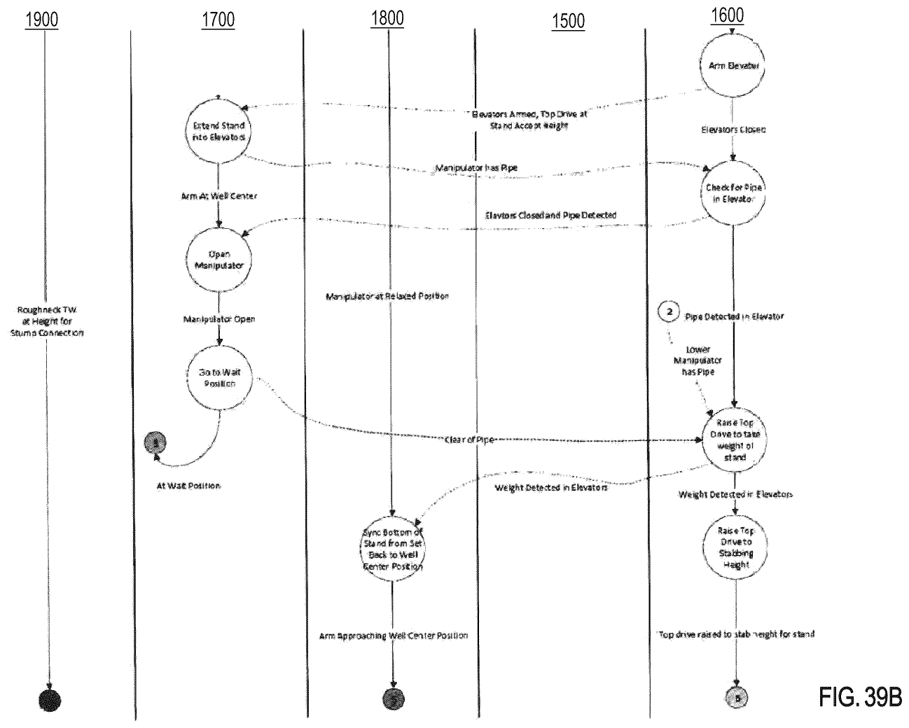

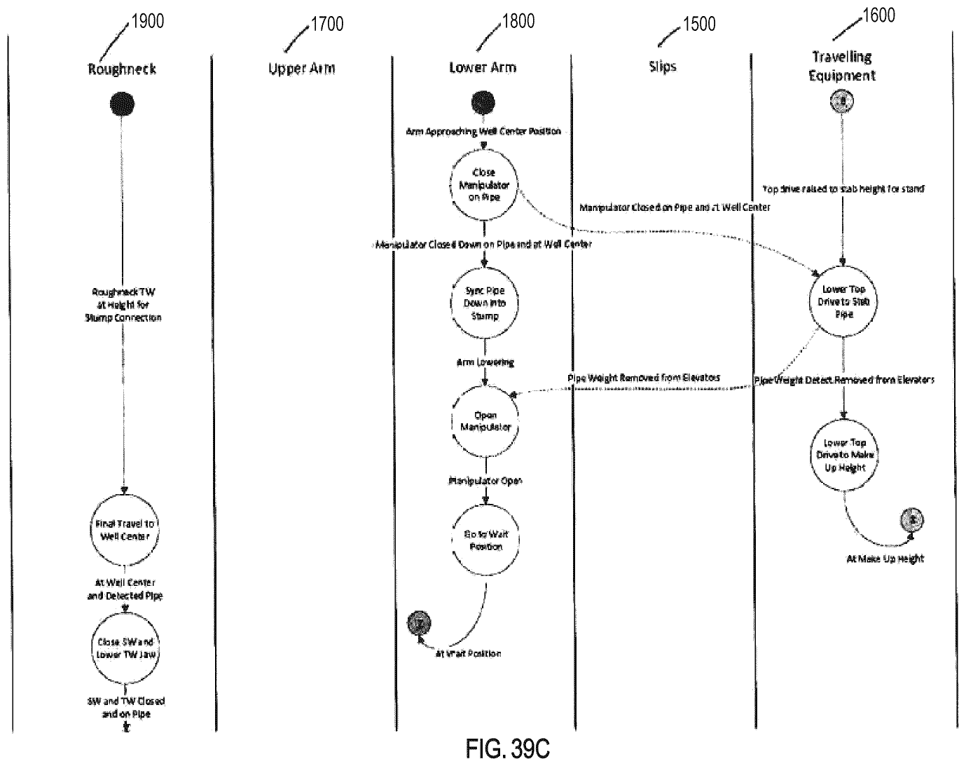

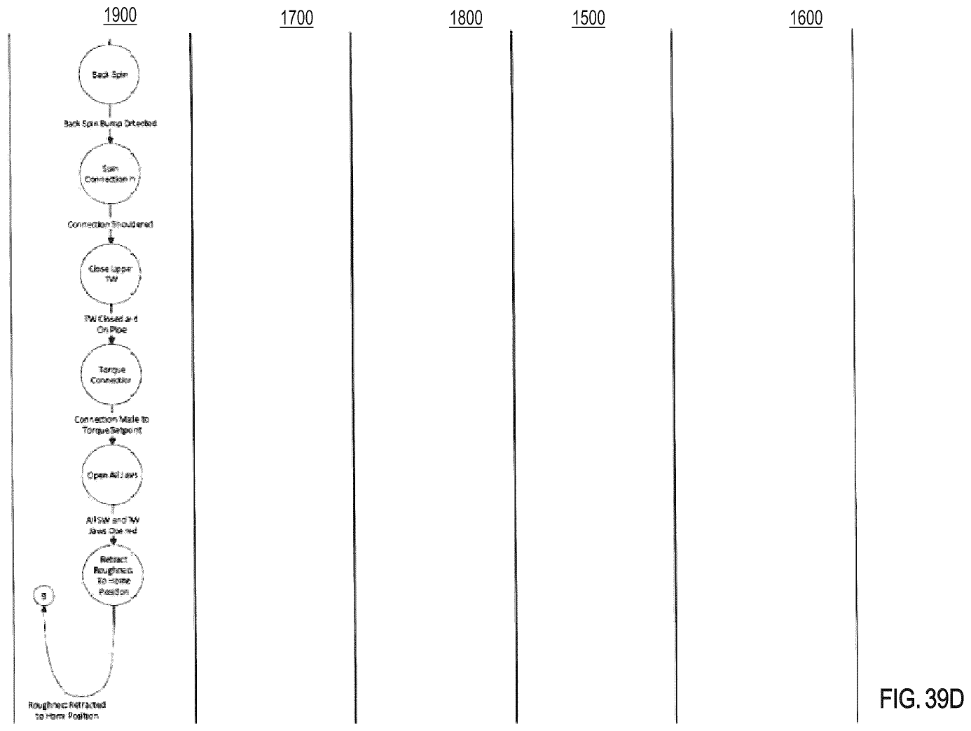

FIGS. 35-38, thus, demonstrate an example of the state machines that may be programmed with respect to at least some components of the pipe handling system. It is to be appreciated that components may be operated in conjunction with one another, wherein some states may rely on others or may rely on feedback received with respect to components of the system. It is further to be appreciated that a variety of feedback devices, sensors, and/or other feedback means may be used to provide the indications for each of the state machines of FIGS. 35-38 to move to a next state. FIGS. 39A-39D illustrate a flow diagram of the state machines discussed with respect to FIGS. 35-38. FIGS. 39A-D also provide an example of operations among the different components, such as the roughneck 1900, upper robot 1700, lower robot 1800, slips 1500, and lifting system 1600, that may be performed simultaneously. For example and as shown in FIG. 39A, as the upper 1700 and lower 1800 robots are moving to a next pipe stand snapshot position and snapshotting the pipe position, the lifting system 1600 may be raising a top drive to take the weight of the drill string, the slips 1500 may be opened, the lifting system may lower the drill string to a stump height for receiving a next pipe stand, and the slips may be closed. Coordination among the various components of the system may additionally be appreciated with respect to FIGS. 39A-D. For example, as shown in FIG. 39B, the upper robot 1700 and lifting system 1600 may operate together to transfer an upper end of the pipe stand from racking board to the elevator. Feedback devices for both components may help to ensure a successful handoff of the pipe stand from the upper robot to the pipe elevator. With reference to FIG. 39C, the lower robot 1800 and lifting system 1600 may work together to align the pipe stand with the drill string and lower the pipe stand onto the drill string. Feedback devices for both components may help to ensure a successful alignment and weight transfer from the elevator to the pipe stand.

It is to be appreciated that a pipe handling system of the present disclosure, or components thereof, may be operable without state machines. For example, in some embodiments, one or more components of the system may be programmed or otherwise configured to operate a timed sequence of events. In this way, rather than responding to feedback data to reach a next state, components of a system may be configured to perform a particular sequence of events, performing particular movements and operations based on timing. As a particular example, during a trip out operation, a lifting system may be used to raise a pipe stand above the drill floor, and based on known amount of time needed to raise the pipe stand given a speed of the lifting system, an upper robot may be programmed to move toward well center and grab the pipe stand based on a known location of where the pipe stand will be at a particular time. In other embodiments, a pipe handling system of the present disclosure, or components thereof, may be operable manually or partially manually. For example, a human operator may control some or all movements of one or more pipe handling robots. In this way, an operator may remain at a safe distance from the pipe stand while controlling the robot(s) remotely. Still other operational methods are contemplated as well.

It is further to be appreciated that pipe handling robots of the present disclosure may be relatively versatile in their handling abilities and performable operations. For example, a pipe handling robot of the present disclosure may be configured to interact with pipe stands arranged throughout the setback area, at other locations on or above the drill floor, and/or throughout the racking board. Using a track or other movement mechanism, as well as pivotable motion about a plurality of jointed connections, each robot may have relatively high flexibility and maneuverability to perform operations. An upper robot or racking board robot may be configured to reach every pipe stand racking location within the racking board, and a lower or drill floor robot may be configured to reach every pipe stand storage location within the setback area of the drill floor. Additionally, pipe handling robots of the present disclosure may be configured to operate in relatively tight space constraints.

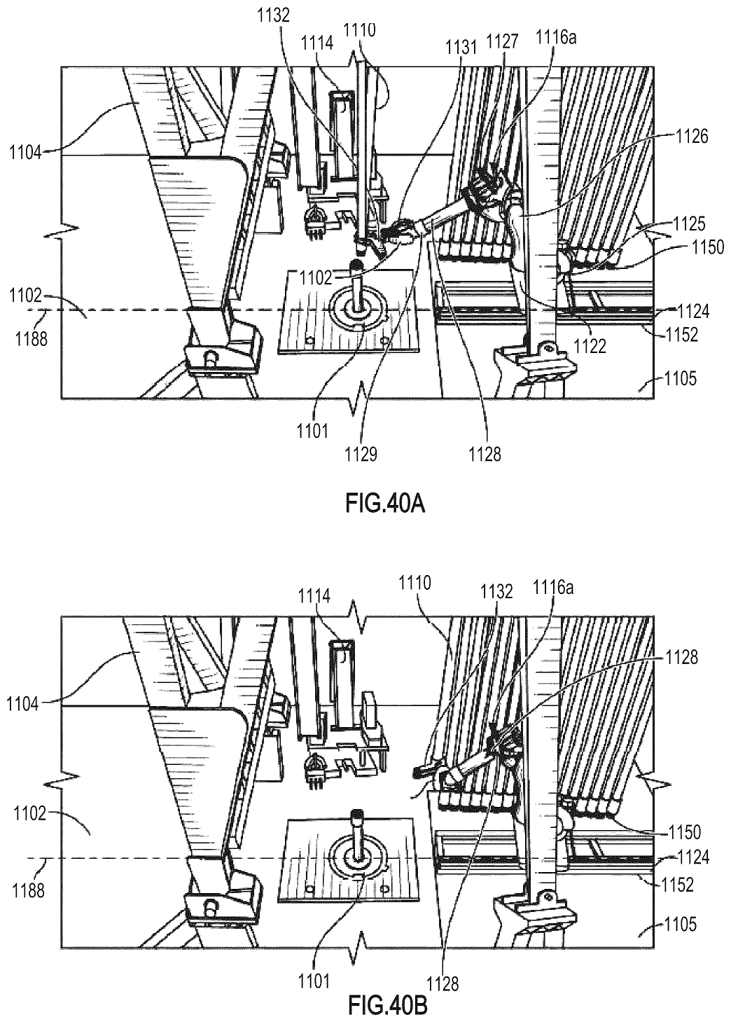

FIGS. 40A and 40B illustrate a drill floor robot 1116a interacting with pipe stands 1110 stored on opposing sides, such as a driller's side and an off-driller's side, of a drill floor 1102. With reference first to FIG. 40A, the joint 1131 between the end effector 1132 and wrist 1130, which may be a yaw joint, may be controlled to orient the end effector toward a first side 1150 of the drill floor 1102, which may be a driller's side or off-driller's side. The robot 1116a may extend toward the well center 1101 by sliding along its track 1124 toward well center and/or by pivotable movement at the joint 1129 between the wrist 1130 and the articulated arm 1128, the joint 1127 between the articulated arm and the shoulder portion 1126, and/or the joint 1125 between the shoulder portion and base portion 1122, each of which may be or include a pitch joint, to extend the end effector toward well center. While directed toward well center 1101, the shoulder portion 1126 and articulated arm 1128 may be maintained in a substantially neutral orientation. That is, the shoulder portion 1126 and articulated arm 1128 may be substantially aligned with the track 1124, along line 88, as shown in FIG. 40A. To position a pipe stand 1110 in the setback area 1105 (or to engage with a drill stand stored in the setback area), the shoulder portion 1126 may pivot about joint 1125 toward the first side 1150 of the drill floor 1102. Additionally or alternatively, the wrist portion 1130 pay pivot about joint 1129 toward the first side 1150, as may be appreciated with respect to FIG. 40B. Depending on a particular pipe stand storage location on the first side 1150, the base portion 1122 may slide along the track 1124 away from well center 1101 if needed, and/or the robot 1116a may be retracted by pivotable movement at each of joints 1131, 1129, and/or 1127. In some embodiments, the robot 1116a may be operated to maintain the shoulder portion 1126 and articulated arm 1128 in a substantially neutral orientation along axis 88 during trip in and trip out operations, while the wrist portion 1130 and/or end effector 1132 pivot to maneuver pipe stands. In some embodiments, trip in and trip out operations may be performed without rotating the articulated arm 1128 and/or shoulder portion 1126 away from the neutral orientation 88 more than approximately 45 degrees.

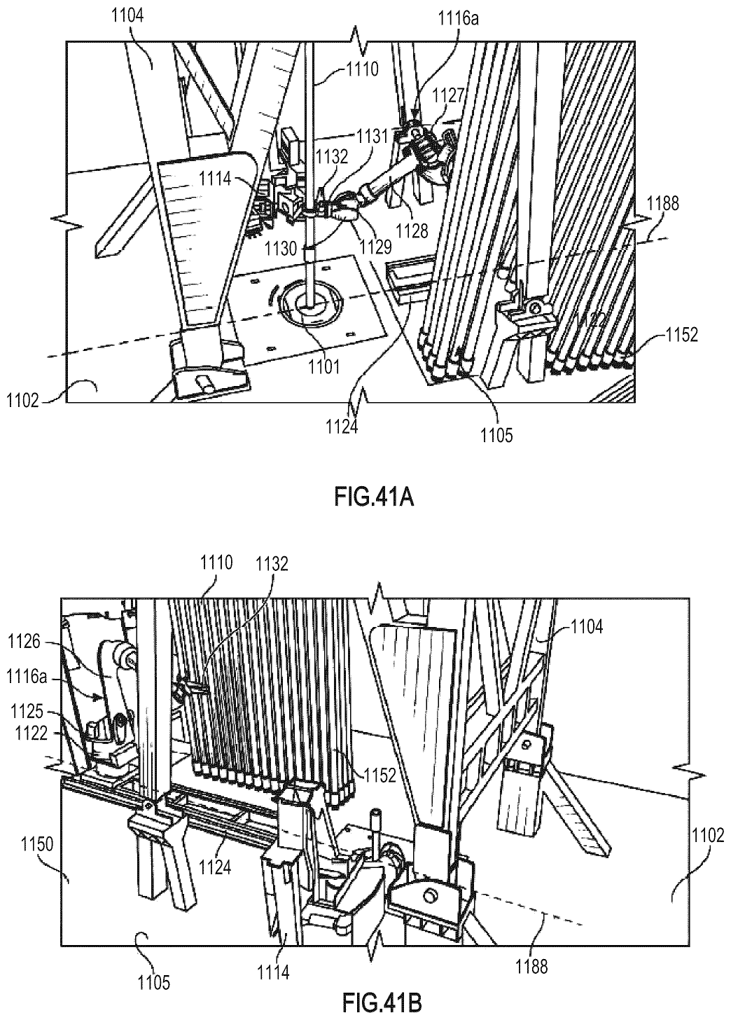

Reversibility of the end effector 1132 may be appreciated with respect to FIGS. 41A and 41B. As shown, to interact with pipe stands 1110 stored, or to be stored, on a second side 1152 of the setback area 1105, the end effector 1132 may be directed toward the second side, and thus rotated approximately 180 degrees from its orientation with respect to the first side 1150 discussed above. FIG. 41B illustrates the shoulder portion 1126 and articulated arm 1128 in a substantially neutral orientation along axis 88 while the base portion 1122 slides along the track 1124 and the wrist portion 1130 rotates about axis 1129 to reach pipe stand 1110 storage locations.

The devices, systems, and methods described herein provide for automated or partially automated pipe handling operations. The automated and partially automated systems and methods described herein may provide for safer pipe handling operations relative to conventional operations. For example, a pipe handling robot of the present disclosure may perform many operations that may otherwise be performed by a human operator. Derrickhands and other human operators often maneuver upper and lower ends of pipe stands during trip in, trip out, and stand building operations. These operations can be dangerous for human operators, particularly due to the size and weight of drill pipes. The pipe handling robots described herein may thus improve the safety of pipe handling operations.

Additionally, systems and methods described herein may improve the efficiency of pipe handling operations relative to conventional operations. In particular, the state machine operations described above may coordinate the operations of system components in order to reduce or minimize lost time. The synchronization and coordination of system components, as described herein, may greatly improve the efficiency of trip in, trip out, and/or stand building operations. The use of pipe handling robots rather than derrickhands and other human operators may increase efficiency and reduce variability of pipe handling operations.

It is to be appreciated that systems and methods of the present disclosure may be relatively cost effective as compared with other automated or partially automated pipe handling systems. In particular, pipe handling systems of the present disclosure may operate using a lifting system that may be operable independent of one or more pipe handling robots. That is, in some embodiments, the pipe handling robots need not have the loading capacity to lift a drill pipe. Rather, the robots may operate to manipulate a length or stand of drill pipe while the lifting system and/or drill floor carries the load of the drill pipe. Pipe handling robots of the present disclosure may thus be more cost effective than robots of other systems. Moreover, in some embodiments, the lifting system may be or include components of the primary drill line and draw works of the drilling rig, without the need to introduce a secondary lifting device or mechanism. However, in other embodiments, a secondary lifting system, device, or mechanism may be used.

For example, in some embodiments, a lifting system of the present disclosure may include a secondary or auxiliary line or cable extending from a draw works. The auxiliary line may operate in addition to the primary or main drill line to facilitate pipe handling operations. In some embodiments, the lifting system may include a dual activity top drive having the ability to engage with a pipe stand with a first elevator while engaging with the drill string with a second elevator, as described in U.S. Provisional Application No. 62/809,093, entitled Dual Activity Top Drive, and filed Feb. 22, 2019, the content of which is hereby incorporated by reference herein in its entirety. In some embodiments, the lifting system may include a robotic drill floor lifting system, which may be or be similar to systems described in U.S. patent application Ser. No. 16/375,927, entitled System for Handling Tubulars on a Rig, and filed Apr. 5, 2019, the content of which is hereby incorporated by reference herein in its entirety. Additionally or alternatively, the lifting system may include an auxiliary lifting arm extending from the drill floor, mast, racking board, or another suitable location on the drilling rig. The lifting arm may be configured for holding a pipe stand above the drill floor while the pipe stand is manipulated by one or pipe handling robots. The lifting arm may be hydraulically or pneumatically actuated in some embodiments. The lifting arm may have a claw or elevator for coupling to or engaging with the pipe stand. In some embodiments, pipe handling operations of the present disclosure may incorporate a first lifting system for handling drill pipe and a second lifting system for handling drill collar.

In some embodiments, one or more robots of the present disclosure may be or include commercially available or off-the-shelf components. For example, one or more pipe handling robots may be or include any of the following: YASKAWA MH225, KAWASAKI BX200, ABB IRB 6620-205, ABB IRB 6700/6790. Other suitable robots and robot components may be used as well.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. (canceled)

2. A robot and tool system for operation on a drill rig, the robot and tool system comprising:
a robot configured for arrangement on a drill floor of a drill rig, the robot comprising a base, an articulated arm operably coupled to the base at a first end and extending to a second end, and a wrist portion arranged on the second end of the articulated arm and being adapted for selectively engaging and disengaging an end effector; and
one or more end effectors arranged at a setting location accessible by the wrist portion of the robot,
wherein the robot is configured to use the one or more end effectors to perform selected operations on the drill rig and is further configured to exchange end effectors to use selected end effectors that correspond to the selected operations.

3. The robot and tool system of claim 2, wherein the robot is arranged on a rail and is movable along the rail between a first position at or near well center and a second position away from well center.

4. The robot and tool system of claim 3, wherein the rail is arranged between two setback areas.

5. The robot and tool system of claim 2, wherein the setting location comprises a fixture for holding an end effector of the one or more end effectors.

6. The robot and tool system of claim 5, wherein selectively engaging and disengaging is by way of motion of the articulated arm relative to the fixture.

7. The robot and tool system of claim 2, wherein the end effector is configured for tubular pipe handling.

8. The robot and tool system of claim 7, wherein the robot is configured to manipulate drill pipe during stand building.

9. The robot and tool system of claim 7, wherein the robot is configured to manipulate drill pipe during trip in operations.

10. The robot and tool system of claim 7, wherein the robot is configured to manipulate drill pipe during trip out operations.

11. The robot and tool system of claim 2, further comprising a passive rotation disconnected for engaging and disengaging the end effectors with the robot.

12. A method of drilling operations, comprising:
using a robot arranged on a drill floor, performing a first selected operation using an end effector that corresponds to the first selected operation;
using the robot, exchanging the end effector with another end effector arranged in a setting location and corresponding to a second selected operation; and
using the robot, performing the second selected operation using the another end effector.

13. The method of claim 12, wherein the end effector is configured for tubular pipe handling.

14. The method of claim 12, wherein the another end effector is configured as a mudbucket.

15. The method of claim 12, wherein the another end effector is configured as a pipe doping tool.

16. The method of claim 12, wherein the another end effector is configured as a stabbing guide.

17. The method of claim 12, further comprising moving the robot along a track toward and away from well center.

18. The method of claim 17, wherein the first selected operation comprises manipulating pipe during trip in operations.

19. The method of claim 17, wherein the first selected operation comprises manipulating pipe during trip out operations.

20. The method of claim 12, wherein the first selected operation comprises manipulating pipe during stand building.

21. The method of claim 12, wherein exchanging the end effector with another end effector comprises using a passive rotation disconnect.
